(19) United States
(12) Patent Application Publication
(10) Pub. No.: US 2026/0308331 A1
(43) Pub. Date: Oct. 8, 2026

(54) POLYCARBONATE-POLYORGANOSILOXANE COPOLYMER, RESIN COMPOSITION, AND MOLDED ARTICLE THEREOF

(71) Applicant: IDEMITSU KOSAN CO., LTD., Tokyo (JP)

(72) Inventors: Yuki OGUSA, Chiyoda-ku, Tokyo (JP); Daisuke YOSHIZAWA, Chiyoda-ku, Tokyo (JP); Yasuhiro ISHIKAWA, Chiyoda-ku, Tokyo (JP)

(73) Assignee: IDEMITSU KOSAN CO., LTD., Tokyo (JP)

(21) Appl. No.: 19/478,753

(22) PCT Filed: Apr. 25, 2024
(86) PCT No.: PCT/JP2024/016332

§ 371 Date: Oct. 24, 2025

(30) Foreign Application Priority Data
Apr. 28, 2023 (JP) 2023-075106

(51) Int. Cl. C08G 77/448; C08G 64/18

(52) U.S. Cl. CPC C08G 77/448; C08G 64/186

(57) ABSTRACT

The present invention relates to a polycarbonate-polyorganosiloxane copolymer including: a polycarbonate block (A-1) including a structural unit represented by the following formula (II); and a polyorganosiloxane block (A-2) including a repeating unit represented by the following formula (III), wherein the ratio of the structural unit represented by the formula (II) to the total of the structural unit represented by the formula (II) and the repeating unit represented by the formula (III) is 60 mass % or more, and a resin composition including the polycarbonate-polyorganosiloxane copolymer and a molded article thereof.

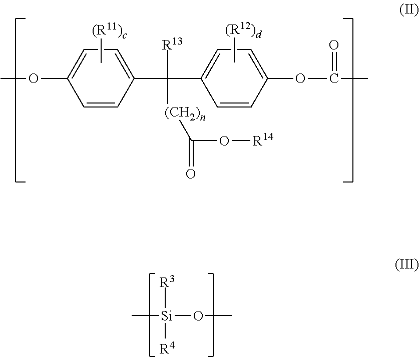

### TECHNICAL FIELD

The present invention relates to a polycarbonate-polyorganosiloxane copolymer, and a resin composition including the polycarbonate-polyorganosiloxane copolymer and a molded article thereof.

### BACKGROUND ART

A polycarbonate-based resin is excellent in, for example, impact resistance, transparency, heat resistance, and self-extinguishing property, and hence has been widely utilized as an engineering plastic in various fields, such as an electrical and electronic equipment field, and an automotive field. However, the polycarbonate-based resin has low surface hardness, and is hence insufficient in scratch resistance in some cases.

In PTL 1, as a polycarbonate copolymer having improved scratch resistance, there is a disclosure of a polycarbonate copolymer including: a unit derived from a hydroxy-terminated monocyclic, polycyclic, or fused cyclic compound having a (meth)acrylate group; and a carbonate unit.

In PTL 2, there are disclosures of a fire-resistant polycarbonate resin, which is branched or crosslinked, and an intermediate thereof.

### CITATION LIST

### Patent Literature

PTL 1: KR 2016-0141268 A
PTL 2: JP H02-219818 A

### SUMMARY OF INVENTION

### Technical Problem

A method including coating the surface of the uppermost layer of a structural body formed of a polycarbonate-based resin has been known as a method of improving the surface hardness thereof. However, there is a problem in that a coating step is required, and hence a production process becomes complicated and an environmental load becomes larger.

Further, the invention described in PTL 1 is insufficient in surface hardness. In PTL 2, there is no description of a method of improving the surface hardness.

As described above, a further investigation has been required for improving the scratch resistance of the polycarbonate-based resin.

An object of the present invention is to provide a polycarbonate-polyorganosiloxane copolymer improved in scratch resistance, and a resin composition including the polycarbonate-polyorganosiloxane copolymer and a molded article thereof.

### Solution to Problem

The inventors of the present invention have found that the above-mentioned problems are solved by a polycarbonate-polyorganosiloxane copolymer including a specific structural unit.

That is, the present invention encompasses the following items 1 to 13.

1. A polycarbonate-polyorganosiloxane copolymer, including:
a polycarbonate block (A-1) including a structural unit represented by the following formula (II); and
a polyorganosiloxane block (A-2) including a repeating unit represented by the following formula (III),
wherein a ratio of the structural unit represented by the formula (II) to a total of the structural unit represented by the formula (II) and the repeating unit represented by the formula (III) is 60 mass % or more:

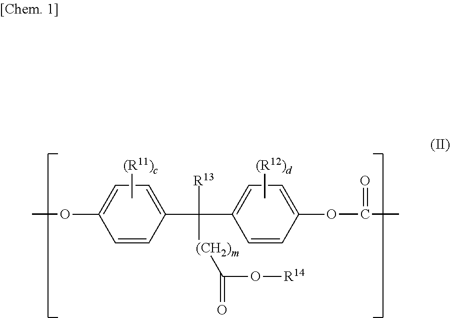

wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a group selected from the group consisting of: a saturated or unsaturated cyclic hydrocarbon group having 3 to 20 carbon atoms; a substituted or unsubstituted alkyl group; and a 3- to 20-membered saturated or unsaturated heterocyclic group,
“c” and “d” each independently represent an integer of from 0 to 4, and
“m” represents an integer of from 0 to 20;

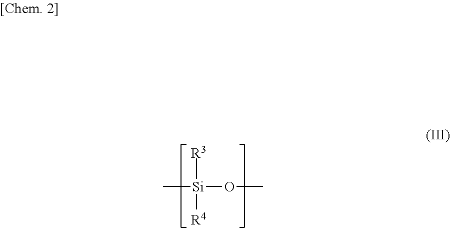

wherein in the formula (III), R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms.

2. The polycarbonate-polyorganosiloxane copolymer according to Item 1, wherein R¹⁴ represents an alkyl group having 1 to 18 carbon atoms, a saturated or unsaturated cyclic hydrocarbon group having 3 to 12 carbon atoms, or a 3- to 12-membered saturated or unsaturated heterocyclic group.

3. The polycarbonate-polyorganosiloxane copolymer according to Item 2, wherein R¹⁴ represents a methyl group, a cyclopentyl group, or a cyclohexyl group.

4. The polycarbonate-polyorganosiloxane copolymer according to any one of Items 1 to 3, wherein “m” represents an integer of from 0 to 4.

5. The polycarbonate-polyorganosiloxane copolymer according to any one of Items 1 to 4, wherein the repeating unit represented by the formula (III) is incorporated as a structural unit represented by any one of the following general formulae (III-I) to (III-III):

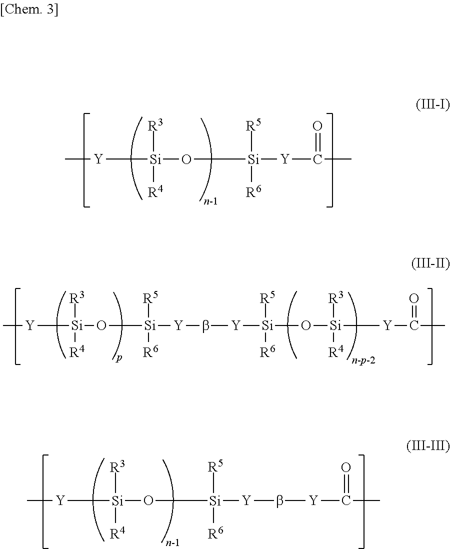

wherein in the formulae (III-I) to (III-III), R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s to R⁶s may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, —R⁷¹R⁷²—, a substituted or unsubstituted arylene group, or a diarylene group, R⁷¹ represents a linear, branched, or cyclic alkylene group, R⁷² represents a substituted or unsubstituted arylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, β represents a divalent group derived from a diisocyanate compound, or a divalent group derived from a dicarboxylic acid or a dicarboxylic acid halide, “n” represents an integer of 21 or more and less than 116, and “p” represents an integer of 1 or more and n−2 or less.

6. The polycarbonate-polyorganosiloxane copolymer according to any one of Items 1 to 5, wherein the polycarbonate block (A-1) further includes a repeating unit represented by the following formula (I):

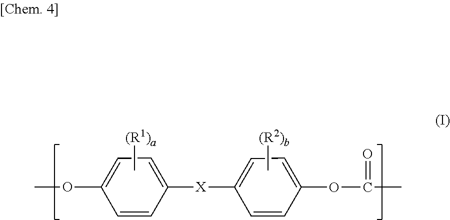

wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 6 to 20 carbon atoms; a cycloalkoxy group having 6 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and
“a” and “b” each independently represent a positive integer of from 0 to 4.

7. The polycarbonate-polyorganosiloxane copolymer according to any one of Items 1 to 6, wherein a total content of the structural unit represented by the formula (II) and the repeating unit represented by the formula (III) is from 5 mass % to 35 mass %.

8. The polycarbonate-polyorganosiloxane copolymer according to any one of Items 1 to 7, wherein the polycarbonate-polyorganosiloxane copolymer has a viscosity-average molecular weight (Mv) of from 10,000 to 40,000.

9. The polycarbonate-polyorganosiloxane copolymer according to any one of Items 1 to 8, wherein “c” and “d” each independently represent an integer of from 1 to 4, and the polycarbonate-polyorganosiloxane copolymer has a viscosity-average molecular weight (Mv) of 22,000 or more.

10. The polycarbonate-polyorganosiloxane copolymer according to any one of Items 1 to 9, wherein a molded article of the polycarbonate-polyorganosiloxane copolymer has a scratch hardness of HB or more, which is evaluated in conformity with JIS K5600 May 4.

11. A resin composition, including the polycarbonate-polyorganosiloxane copolymer of any one of Items 1 to 10.

12. A molded article of the resin composition of Item 11.

13. The molded article according to Item 12, wherein the molded article is a resin window, a touch panel, an interior supply, an exterior supply, an interior part or an exterior part of a vehicle, a casing, an electric appliance, a building material, or OA equipment.

### Advantageous Effects of Invention

The present invention can provide the polycarbonate-polyorganosiloxane copolymer improved in scratch resistance, and the resin composition including the polycarbonate-polyorganosiloxane copolymer and the molded article thereof.

### DESCRIPTION OF EMBODIMENTS

A polycarbonate-polyorganosiloxane copolymer of the present invention, and a resin composition including the polycarbonate-polyorganosiloxane copolymer and a molded article thereof are described in detail below. In this description, a specification considered to be preferred may be arbitrarily adopted, and it can be said that a combination of preferred specifications is more preferred. The term “XX to YY” as used herein means “XX or more and YY or less.”

### 1. Polycarbonate-Polyorganosiloxane Copolymer

The polycarbonate-polyorganosiloxane copolymer (hereinafter also referred to as “PC-POS copolymer”) of the present invention includes: a polycarbonate block (A-1) including a structural unit represented by the following formula (II); and a polyorganosiloxane block (A-2) including a repeating unit represented by the following formula (III). In addition, the ratio of the structural unit represented by the formula (II) to the total of the structural unit represented by the formula (II) and the repeating unit represented by the formula (III) is 60 mass % or more.

The ratio of the structural unit represented by the formula (II) to the total of the structural unit represented by the formula (II) and the repeating unit represented by the formula (III) in the PC-POS copolymer is 60 mass % or more, preferably 63 mass % or more, more preferably 65 mass % or more, and is preferably 97 mass % or less, more preferably 95 mass % or less, still more preferably 93 mass % or less, still further more preferably 90 mass % or less. In addition, the ratio of the structural unit represented by the formula (II) to the total of the structural unit represented by the formula (II) and the repeating unit represented by the formula (III) in the PC-POS copolymer is from 60 mass % to 97 mass %, preferably from 63 mass % to 95 mass %, more preferably from 65 mass % to 93 mass %, still more preferably from 65 mass % to 90 mass %.

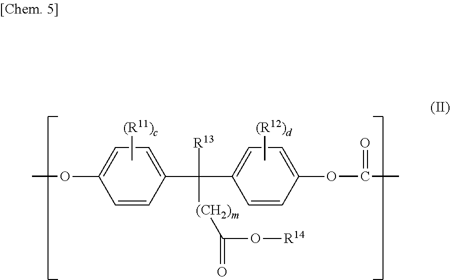

wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl (arylalkylene) group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a group selected from the group consisting of: a saturated or unsaturated cyclic hydrocarbon group having 3 to 20 carbon atoms; a substituted or unsubstituted alkyl group; and a 3- to 20-membered saturated or unsaturated heterocyclic group,
“c” and “d” each independently represent a positive integer of from 0 to 4, and
“m” represents a positive integer of from 0 to 20.

Examples of the halogen atom that R¹¹ and R¹² in the formula (II) each independently represent include a fluorine atom, a chlorine atom, a bromine atom, and an iodine atom.

Examples of the alkyl group having 1 to 18 carbon atoms that R¹¹ and R¹² each independently represent include a methyl group, an ethyl group, a n-propyl group, an isopropyl group, various butyl groups (the term “various” as used herein means that a linear group and all kinds of branched groups are included, and the same holds true for the following), various pentyl groups, and various hexyl groups.

Examples of the alkoxy group having 1 to 18 carbon atoms that R¹¹ and R¹² each independently represent include alkoxy groups whose alkyl group moieties are the above-mentioned alkyl groups.

Examples of the cycloalkyl group having 3 to 20 carbon atoms that R¹¹ and R¹² each independently represent include a cyclopropyl group, a cyclobutyl group, a cyclopentyl group, a cyclohexyl group, and a cycloheptyl group.

Examples of the cycloalkoxy group having 3 to 20 carbon atoms that R¹¹ and R¹² each independently represent include cycloalkoxy groups whose cycloalkyl group moieties are the above-mentioned cycloalkyl groups.

Examples of the alkenyl group having 2 to 10 carbon atoms that R¹¹ and R¹² each independently represent include an ethenyl group, a propenyl group, a butenyl group, a pentenyl group, and a hexenyl group.

Examples of the aryl group having 6 to 14 carbon atoms that R¹¹ and R¹² each independently represent include a phenyl group, a naphthyl group, a biphenyl group, and an anthryl group.

Examples of the aryloxy group having 6 to 14 carbon atoms that R¹¹ and R¹² each independently represent include aryloxy groups whose aryl group moieties are the above-mentioned aryl groups.

Examples of the aralkyl group having 7 to 20 carbon atoms that R¹¹ and R¹² each independently represent include a phenylmethyl group and a phenylethyl group.

Examples of the aralkyloxy group having 7 to 20 carbon atoms that R¹¹ and R¹² each independently represent include aralkyloxy groups whose aralkyl group moieties are the above-mentioned aralkyl groups.

Examples of the alkyl group having 1 to 5 carbon atoms represented by R¹³ in the formula (II) include a methyl group, an ethyl group, a n-propyl group, an isopropyl group, various butyl groups, and various pentyl groups.

Examples of the cycloalkyl group having 3 to 20 carbon atoms represented by R¹³ include a cyclopropyl group, a cyclobutyl group, a cyclopentyl group, a cyclohexyl group, and a cycloheptyl group.

Examples of the cycloalkoxy group having 3 to 20 carbon atoms represented by R¹³ include cycloalkoxy groups whose cycloalkyl group moieties are the above-mentioned cycloalkyl groups.

Examples of the alkenyl group having 2 to 10 carbon atoms represented by R¹³ include an ethenyl group, a propenyl group, a butenyl group, a pentenyl group, and a hexenyl group.

Examples of the aryl group having 6 to 14 carbon atoms represented by R¹³ include a phenyl group, a naphthyl group, a biphenyl group, and an anthryl group.

The saturated or unsaturated cyclic hydrocarbon group represented by R¹⁴ in the formula (II) has 3 to 20 carbon atoms, preferably 3 to 12 carbon atoms, more preferably 4 to 9 carbon atoms. Specific examples thereof include: cycloalkyl groups serving as saturated alicyclic groups, such as a cyclopropyl group, a cyclobutyl group, a cyclopentyl group, a cyclohexyl group, a cycloheptyl group, an adamantyl group, a trimethylcyclohexyl group, and a norbornyl group; cycloalkenyl groups serving as unsaturated alicyclic groups, such as a cyclopropenyl group, a cyclobutenyl group, a cyclopentenyl group, a cyclohexenyl group, and a cycloheptenyl group; and aryl groups, such as a phenyl group, a naphthyl group, a biphenyl group, and an anthryl group.

Examples of the substituted or unsubstituted alkyl group represented by R¹⁴ include: unsubstituted alkyl groups each having 1 to 18 carbon atoms, such as a methyl group, an ethyl group, a n-propyl group, an isopropyl group, various butyl groups, various pentyl groups, and various hexyl groups; and substituted alkyl groups such as a benzyl group.

The number of atoms for forming the ring of the heterocyclic group represented by R¹⁴ is from 3 to 20, and the ring has preferably 3 to 12 carbon atoms, more preferably 3 to 8 carbon atoms. The heterocyclic group is a cyclic group containing at least one heteroatom, for example, one, two, or three heteroatoms as ring-forming atoms. Specific examples of the heteroatom include a nitrogen atom, an oxygen atom, a sulfur atom, a silicon atom, a phosphorus atom, and a boron atom.

Examples of the heterocyclic group include a pyridinyl group, a pyrazinyl group, a pyrimidinyl group, a pyridazinyl group, a triazinyl group, an indolinyl group, a quinolinyl group, an acridinyl group, a pyrrolidinyl group, a dioxanyl group, a piperidinyl group, an oxiranyl group (epoxy group), an oxetanyl group, a morpholinyl group, a piperazinyl group, a carbazolyl group, a furanyl group, a thiophenyl group, an oxazolyl group, an oxadiazolyl group, a benzoxazolyl group, a thiazolyl group, a thiadiazolyl group, a benzothiazolyl group, a triazolyl group, an imidazolyl group, a benzimidazolyl group, and a furanyl group.

R¹⁴ preferably represents an alkyl group having 1 to 18 carbon atoms, a saturated or unsaturated cyclic hydrocarbon group having 3 to 12 carbon atoms, or a 3- to 12-membered saturated or unsaturated heterocyclic group, more preferably represents an alkyl group having 1 to 3 carbon atoms, or a cycloalkyl group having 3 to 8 carbon atoms, and still more preferably represents a methyl group, a cyclopentyl group, or a cyclohexyl group.

“c” and “d” each independently represent an integer of from 0 to 4, preferably an integer of from 0 to 2, more preferably 0 or 1, still more preferably 0. In addition, in another aspect, “c” and “d” each independently represent an integer of from 0 to 4, preferably an integer of from 1 to 4, more preferably 1 or 2, still more preferably 1.

“m” represents an integer of from 0 to 20, preferably an integer of from 0 to 10, more preferably an integer of from 0 to 4, still more preferably from 0 to 2.

In a preferred aspect of the formula (II), from the viewpoint of improving the scratch resistance of the polycarbonate-polyorganosiloxane copolymer, R¹⁴ represents a methyl group, a cyclopentyl group, or a cyclohexyl group, and “m” represents preferably from 0 to 2, more preferably 2. In addition, “c” and “d” each preferably represent 0 or 1, and R¹³ represents preferably an alkyl group having 1 to 3 carbon atoms, more preferably a methyl group.

In the PC-POS copolymer, the structural units each represented by the formula (II) may be used alone or in combination thereof.

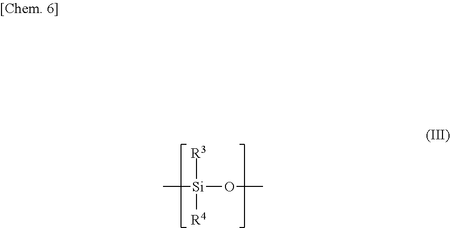

wherein in the formula (III), R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms.

Examples of the halogen atom that R³ and R⁴ in the formula (III) each independently represent include a fluorine atom, a chlorine atom, a bromine atom, and an iodine atom.

Examples of the alkyl group having 1 to 6 carbon atoms that R³ and R⁴ each independently represent include a methyl group, an ethyl group, a n-propyl group, an isopropyl group, various butyl groups, various pentyl groups, and various hexyl groups.

Examples of the alkoxy group having 1 to 6 carbon atoms that R³ and R⁴ each independently represent include alkoxy groups whose alkyl group moieties are the above-mentioned alkyl groups.

Examples of the aryl group having 6 to 12 carbon atoms that R³ and R⁴ each independently represent include a phenyl group and a naphthyl group.

R³ and R⁴ each preferably represent a hydrogen atom, an alkyl group having 1 to 6 carbon atoms, an alkoxy group having 1 to 6 carbon atoms, or an aryl group having 6 to 12 carbon atoms, and each more preferably represent a methyl group.

The average number of repetitions of the polyorganosiloxane block (A-2) in the PC-POS copolymer is preferably from 20 to 115, more preferably from 25 to 110, still more preferably from 30 to 105, still further more preferably from 35 to 100. When the average number of repetitions falls within the above-mentioned ranges, the impact resistance of the polycarbonate-polyorganosiloxane copolymer can be improved.

The term “average number of repetitions of the polyorganosiloxane block (A-2)” refers to the average of the numbers of —SiR³R⁴-groups per polyorganosiloxane block (A-2) present between the two closest polycarbonate bonds on the main chain of the PC-POS copolymer. In addition, the average number of repetitions of the repeating unit represented by the formula (III) in the polyorganosiloxane block (A-2) is represented by n−1.

The average number “n” of repetitions of the polyorganosiloxane block (A-2) in the PC-POS copolymer is calculated by nuclear magnetic resonance (NMR) measurement.

The repeating unit represented by the formula (III) in the polycarbonate-polyorganosiloxane copolymer is preferably incorporated as a structural unit represented by any one of the following formulae (III-I) to (III-III) into the polyorganosiloxane block (A-2).

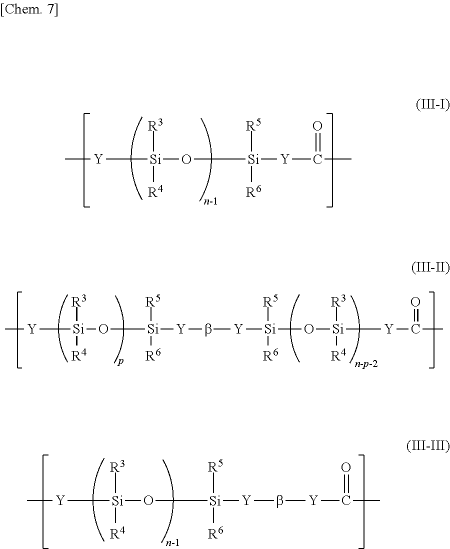

wherein in the formulae (III-I) to (III-III), R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s to R⁶s may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, —R⁷¹R⁷²—, a substituted or unsubstituted arylene group, or a diarylene group, R⁷¹ represents a linear, branched, or cyclic alkylene group, R⁷² represents a substituted or unsubstituted arylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, β represents a divalent group derived from a diisocyanate compound, or a divalent group derived from a dicarboxylic acid or a dicarboxylic acid halide, “n” represents an integer of 21 or more and less than 116, and “p” represents an integer of 1 or more and n−2 or less.

Examples of the halogen atom that R³ to R⁶ each independently represent include a fluorine atom, a chlorine atom, a bromine atom, and an iodine atom.

Examples of the alkyl group having 1 to 6 carbon atoms that R³ to R⁶ each independently represent include a methyl group, an ethyl group, a n-propyl group, an isopropyl group, various butyl groups, various pentyl groups, and various hexyl groups.

Examples of the alkoxy group having 1 to 6 carbon atoms that R³ to R⁶ each independently represent include alkoxy groups whose alkyl group moieties are the above-mentioned alkyl groups.

Examples of the aryl group having 6 to 12 carbon atoms that R³ to R⁶ each independently represent include a phenyl group and a naphthyl group.

R³ to R⁶ each preferably represent a hydrogen atom, an alkyl group having 1 to 6 carbon atoms, an alkoxy group having 1 to 6 carbon atoms, or an aryl group having 6 to 12 carbon atoms.

R³ to R⁶ in the formula (III-I), the formula (III-II), and/or the formula (III-III) each preferably represent a methyl group.

In —R⁷O—, —R⁷COO—, —R⁷NH—, —R⁷NR⁸—, —R⁷COO—R⁹—O—, or —R⁷O—R¹⁰—O— represented by Y, R⁷ is bonded to a Si atom. In —COO— represented by Y, a C atom is bonded to the Si atom.

The linear or branched alkylene group represented by R⁷ in —R⁷O—, —R⁷COO—, —R⁷NH—, —R⁷NR⁸—, —R⁷COO—R⁹—O—, or —R⁷O—R¹⁰—O— represented by Y is, for example, an alkylene group having 1 to 8 carbon atoms, preferably 1 to 5 carbon atoms. The cyclic alkylene group represented by R⁷ is, for example, a cycloalkylene group having 5 to 15 carbon atoms, preferably 5 to 10 carbon atoms.

—R⁷¹R⁷²— represented by R⁷ may have a substituent, such as an alkoxy group or an alkyl group, on the arylene group represented by R⁷², and a specific structure thereof may be, for example, a structure represented by the following formula (1) or (2). Herein, when R⁷ represents —R⁷¹R⁷²—, the alkylene group represented by R⁷¹ is bonded to a Si atom.

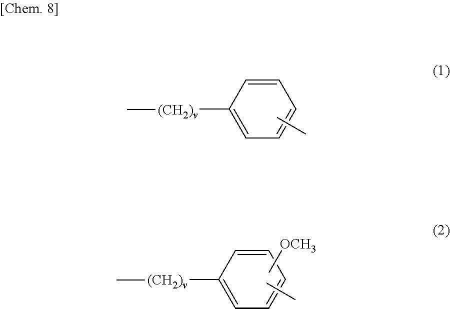

wherein in the formulae (1) and (2), “v” represents a positive integer, and typically represents an integer of from 1 to 6.

The diarylene group represented by each of R⁷, R⁹, and R¹⁰ is a group obtained by linking two arylene groups directly or through a divalent organic group, and is specifically a group having a structure represented by —Ar¹—W—Ar²—. Herein, Ar¹ and Ar² each represent an arylene group, and W represents a single bond or a divalent organic group. Examples of the divalent organic group represented by W include an isopropylidene group, a methylene group, a dimethylene group, and a trimethylene group.

Examples of the arylene group represented by each of R⁷, Ar¹, and Ar² include arylene groups each having 6 to 14 ring-forming carbon atoms, such as a phenylene group, a naphthylene group, a biphenylene group, and an anthrylene group. Those arylene groups may each have an optional substituent, such as an alkoxy group or an alkyl group.

The alkyl group represented by R⁸ is a linear or branched alkyl group having 1 to 8, preferably 1 to 5 carbon atoms. The alkenyl group represented by R⁸ is, for example, a linear or branched alkenyl group having 2 to 8, preferably 2 to 5 carbon atoms. The aryl group represented by R⁸ is, for example, a phenyl group or a naphthyl group. The aralkyl group represented by R⁸ is, for example, a phenylmethyl group or a phenylethyl group.

The linear, branched, or cyclic alkylene group represented by R¹⁰ is the same as that of R⁷.

Y preferably represents —R⁷O— where R⁷ represents —R⁷¹R⁷²—. R⁷ represents more preferably a phenol-based compound residue having, in particular, an alkyl group, still more preferably an allylphenol-derived organic residue or a eugenol-derived organic residue among them.

With regard to “p” in the formula (III-II), p=n−p−2 is preferably satisfied.

β represents a divalent group derived from a diisocyanate compound, or a divalent group derived from a dicarboxylic acid or a dicarboxylic acid halide, and examples thereof include divalent groups represented by the following formulae (3) to (7).

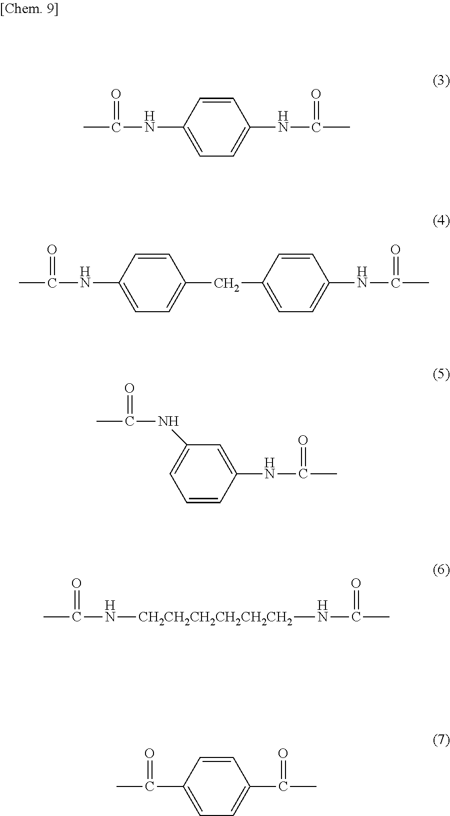

A block unit represented by the following formula (III-I) is, for example, a block unit represented by any one of the following formulae (III-I-1) to (III-I-11):

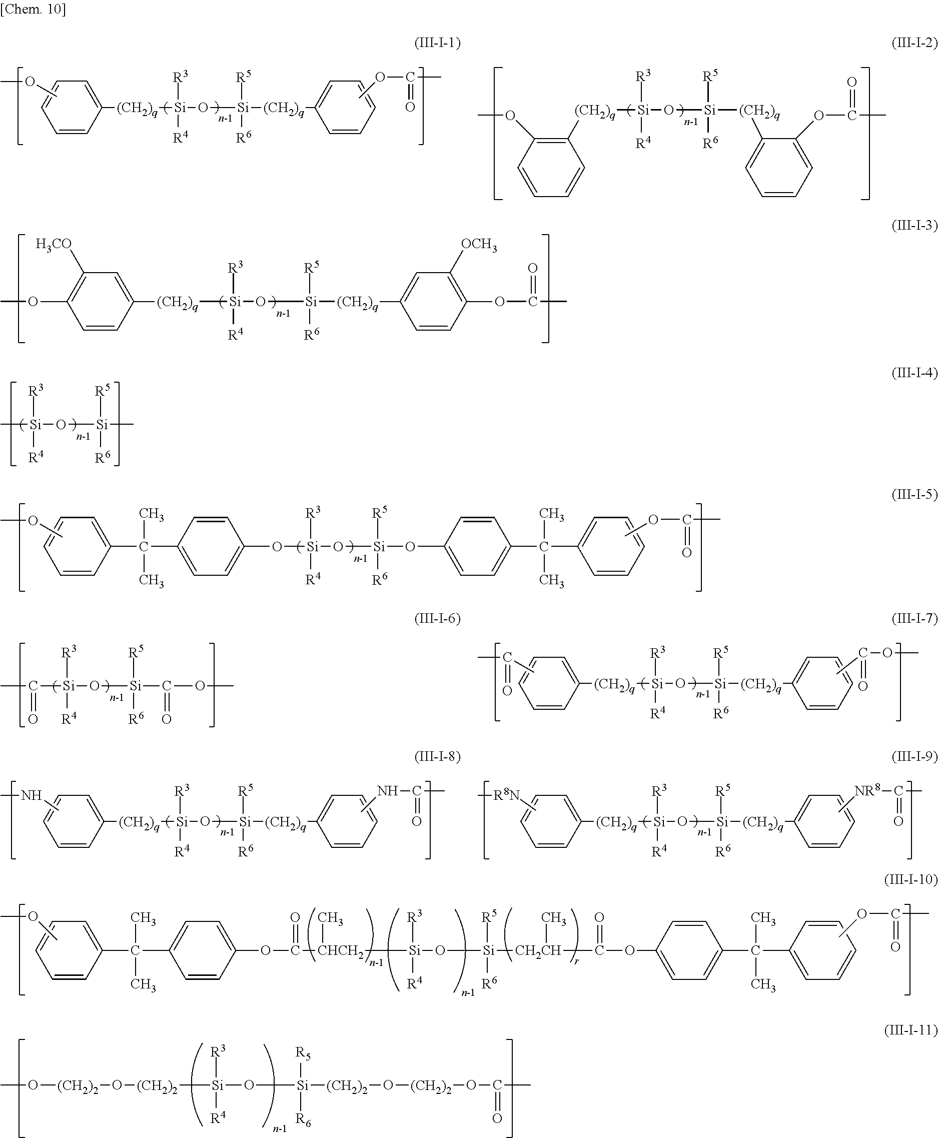

wherein in the formulae (III-I-1) to (III-I-11), R³ to R⁶, n−1, and R⁸ are the same as those described above, and preferred examples thereof are also the same as those described above, and “q” and “r” each independently represent a positive integer, and each typically represent an integer of from 1 to 6.

Among them, the block unit represented by the formula (III-I-1) is preferred from the viewpoint of the ease with which a polyorganosiloxane is polymerized. In addition, the block unit represented by the formula (III-I-2) or the block unit represented by the formula (III-I-3) is preferred from the viewpoint of ease of availability.

In addition, another preferred aspect of the polyorganosiloxane block (A-2) is, for example, a block unit represented by the following formula (III-IV):

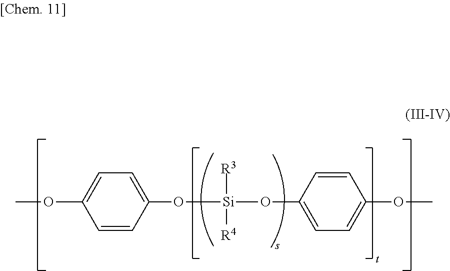

wherein in the formula (III-IV), R³ and R⁴ are the same as those described above, and s×t is equal to the above-mentioned “n”.

The content of the structural unit represented by the formula (II) in the PC-POS copolymer is preferably from 2 mass % to 40 mass %, more preferably from 4 mass % to 35 mass %, still more preferably from 6 mass % to 30 mass %, still further more preferably from 7 mass % to 25 mass %.

The content of the repeating unit represented by the formula (III) in the PC-POS copolymer is preferably from 0.4 mass % to 20 mass %, more preferably from 0.6 mass % to 17 mass %, still more preferably from 0.8 mass % to 15 mass %, still further more preferably from 1 mass % to 13 mass %.

In view of the foregoing, the total content of the structural unit represented by the formula (II) and the repeating unit represented by the formula (III) in the PC-POS copolymer is preferably from 5 mass % to 35 mass %, more preferably from 6 mass % to 34 mass %, still more preferably from 7 mass % to 33 mass %, still further more preferably from 8 mass % to 32 mass %.

The term “content of the structural unit represented by the formula (II)” as used herein refers to the percentage of the mass of the structural unit represented by the formula (II) to the total mass of the structural unit represented by the formula (II), the repeating unit represented by the formula (III), and a repeating unit represented by the formula (I) to be described later that the PC-POS copolymer includes as required. The same holds true for the “content of the repeating unit represented by the formula (III)” and the “content of the repeating unit represented by the formula (I)” to be described later.

The content of the structural unit represented by the formula (II) in the PC-POS copolymer is calculated by nuclear magnetic resonance (NMR) measurement. Specifically, the content is calculated from a peak derived from the structural unit represented by the formula (II), a peak derived from the repeating unit represented by the formula (III), and a peak derived from the repeating unit represented by the formula (I), which are obtained by performing 1H-NMR measurement.

The polycarbonate block (A-1) may further include a repeating unit represented by the following formula (I):

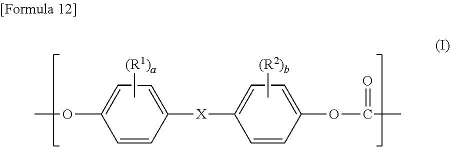

wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 6 to 20 carbon atoms; a cycloalkoxy group having 6 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and
“a” and “b” each independently represent an integer of from 0 to 4.

Examples of the halogen atom that R¹ and R² in the formula (I) each independently represent include a fluorine atom, a chlorine atom, a bromine atom, and an iodine atom.

Examples of the alkyl group having 1 to 18 carbon atoms that R¹ and R² each independently represent include a methyl group, an ethyl group, a n-propyl group, an isopropyl group, various butyl groups, various pentyl groups, and various hexyl groups.

Examples of the alkoxy group having 1 to 18 carbon atoms that R¹ and R² each independently represent include alkoxy groups whose alkyl group moieties are the above-mentioned alkyl groups.

Examples of the cycloalkyl group having 6 to 20 carbon atoms that R¹ and R² each independently represent include a cyclopropyl group, a cyclobutyl group, a cyclopentyl group, a cyclohexyl group, and a cycloheptyl group.

Examples of the cycloalkyl group having 6 to 20 carbon atoms that R¹ and R² each independently represent include cycloalkoxy groups whose cycloalkyl group moieties are the above-mentioned cycloalkyl groups.

Examples of the alkenyl group having 2 to 10 carbon atoms that R¹ and R² each independently represent include an ethenyl group, a propenyl group, a butenyl group, a pentenyl group, and a hexenyl group.

Examples of the aryl group having 6 to 14 carbon atoms that R¹ and R² each independently represent include a phenyl group, a naphthyl group, a biphenyl group, and an anthryl group.

Examples of the aryloxy group having 6 to 14 carbon atoms that R¹ and R² each independently represent include aryloxy groups whose aryl group moieties are the above-mentioned aryl groups.

Examples of the aralkyl group having 7 to 20 carbon atoms that R¹ and R² each independently represent include a phenylmethyl group and a phenylethyl group.

Examples of the aralkyloxy group having 7 to 20 carbon atoms that R¹ and R² each independently represent include aralkyloxy groups whose aralkyl group moieties are the above-mentioned aralkyl groups.

The alkylene group represented by X has 1 to 8 carbon atoms, preferably 1 to 5 carbon atoms. Specific examples thereof include a methylene group, an ethylene group, a trimethylene group, a tetramethylene group, and a hexamethylene group.

Examples of the alkylidene group represented by X include an ethylidene group and an isopropylidene group.

The cycloalkylene group represented by X has 5 to 15 carbon atoms, preferably 5 to 10 carbon atoms. Specific examples thereof include a cyclopentanediyl group, a cyclohexanediyl group, and a cyclooctanediyl group.

Examples of the arylene group represented by X include a phenylene group, a naphthylene group, a biphenylene group, and a tetraphenyl group.

The cycloalkylidene group represented by X has 5 to 15 carbon atoms, preferably 5 to 10 carbon atoms. Specific examples thereof include a cyclohexylidene group, a 3,5,5-trimethylcyclohexylidene group, and a 2-adamantylidene group.

The aralkyl group represented by X has 7 to 20 carbon atoms, and examples of the aryl moiety thereof include aryl groups each having 6 to 14 ring-forming carbon atoms, such as a phenyl group, a naphthyl group, a biphenyl group, and an anthryl group.

A case in which X represents an isopropylidene group, a cyclohexylidene group, or a 3,5,5-trimethylcyclohexylidene group among those described above is preferred because the scratch resistance of a molded article of the PC-POS copolymer can be improved.

“a” and “b” each independently represent an integer of from 0 to 4, preferably from 0 to 2, more preferably 0 or 1.

Among them, a case in which “a” and “b” each represent 0, and X represents a single bond or an alkylene group having 1 to 8 carbon atoms, or a case in which “a” and “b” each represent 0, and X represents an alkylidene group, in particular, an isopropylidene group is suitable.

In addition, as another aspect, a case in which “a” and “b” each represent 1, and X represents a single bond or an alkylene group having 1 to 8 carbon atoms, or a case in which “a” and “b” each represent 1, and X represents an alkylidene group, in particular, an isopropylidene group is also preferred because the scratch resistance of the molded article of the PC-POS copolymer can be improved.

Specific examples of the repeating unit represented by the formula (I) include repeating units represented by the following general formulae (I-i) to (I-iv).

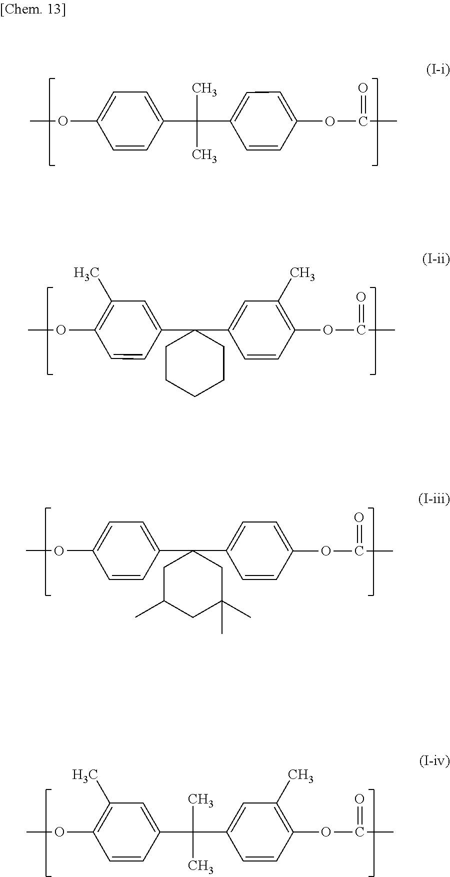

In the PC-POS copolymer, the repeating units each represented by the formula (I) may be used alone or in combination thereof. Specifically, for example, the following aspects are given: an aspect in which the copolymer is formed only of the repeating unit represented by the general formula (I-i); and an aspect in which the copolymer is formed of a combination of the repeating unit represented by the general formula (I-i), and one or more kinds selected from the group consisting of the repeating units represented by the general formulae (I-ii) to (I-iv). Such PC-POS copolymer may be easily produced by an interfacial polymerization method in which a polycarbonate oligomer to be described later is produced in advance.

When the above-mentioned PC-POS copolymer includes the repeating unit represented by the formula (I), the PC-POS copolymer is a polycarbonate-polyorganosiloxane copolymer including: the repeating unit represented by the formula (I); the structural unit represented by the formula (II); and the repeating unit represented by the formula (III).

In the above-mentioned PC-POS copolymer, a mass ratio ((I):(II)+(III)) between the repeating unit represented by the formula (I), and the total of the structural unit represented by the formula (II) and the repeating unit represented by the formula (III) is preferably from 50:50 to 99:1, more preferably from 55:45 to 97:3, still more preferably from 60:40 to 95:5, still further more preferably from 65:35 to 93:7, most preferably from 70:30 to 92:8.

A molar ratio between the repeating unit represented by the formula (I), and the total of the structural unit represented by the formula (II) and the repeating unit represented by the formula (III) in the PC-POS copolymer is calculated by nuclear magnetic resonance (NMR) measurement. Specifically, the ratio is calculated from the integrated values of the peak derived from the repeating unit represented by the formula (I), the peak derived from the structural unit represented by the formula (II), and the peak derived from the repeating unit represented by the formula (III), which are obtained by performing 1H-NMR measurement.

The PC-POS copolymer of the present invention may include a constituent unit except the structural unit represented by the formula (II) and the repeating unit represented by the formula (III), and as required, the repeating unit represented by the formula (I). Such unit is, for example, a terminal structure derived from a terminal stopper to be described later.

The viscosity-average molecular weight (Mv) of the above-mentioned PC-POS copolymer is preferably from 10,000 to 40,000, more preferably from 12,000 to 35,000, still more preferably from 14,000 to 30,000, still further more preferably from 15,000 to 28,000 in terms of its mechanical characteristics and moldability.

In addition, when “c” and “d” in the structural unit represented by the formula (II) each represent an integer of from 1 to 4, the viscosity-average molecular weight (Mv) of the above-mentioned PC-POS copolymer is preferably from 22,000 to 40,000, more preferably from 22,000 to 30,000, still more preferably from 22,000 to 28,000, still further more preferably from 22,000 to 25,000 in terms of its mechanical characteristics and moldability.

In the present invention, the viscosity-average molecular weight (Mv) is calculated from the following Schnell's equation after the determination of a limiting viscosity [η] through the measurement of the viscosity of a methylene chloride solution (concentration: g/L) at 20° C. with an Ubbelohde-type viscometer.

$$[ η ] = 1.23 \times 1 {0}^{- 5} {Mv}^{0.83}$$

The molded article of the PC-POS copolymer of the present invention can be improved in scratch resistance.

The scratch resistance may be evaluated by scratch hardness (pencil method). The scratch hardness (pencil method) of the molded article of the above-mentioned PC-POS copolymer evaluated in conformity with JIS K5600 May 4:1999 is preferably HB or more.

### 2. Method of Producing Polycarbonate-Polyorganosiloxane Copolymer

The above-mentioned PC-POS copolymer may be produced by a known method of producing a polycarbonate-based resin. Examples of the known method of producing a polycarbonate-based resin include:
(i) an interfacial polymerization method (phosgene method) including causing a dihydric phenol-based compound and phosgene to react with each other in the presence of an organic solvent inert to the reaction and an aqueous alkali solution, and then adding a polymerization catalyst, such as a tertiary amine or a quaternary ammonium salt, to polymerize the resultant;
(ii) a melt polymerization method (ester exchange method) including subjecting the dihydric phenol-based compound and a carbonic acid diester to an ester exchange reaction under a molten state in which no solvent is used through the addition of a basic catalyst; and
(iii) a pyridine method including dissolving the dihydric phenol-based compound in pyridine or a mixed solution containing pyridine and an inert solvent, and introducing phosgene into the solution to directly produce the resin.

A molecular weight modifier (terminal stopper), a branching agent, or the like is used as required in the above-mentioned reaction.

In particular, a method of producing a polycarbonate-based resin, which includes a step of subjecting the dihydric phenol-based compound and a polycarbonate oligomer polymerized in advance to interfacial polycondensation in the presence of a water-insoluble organic solvent and an aqueous solution of an alkali compound, is preferred.

Specifically, the polycarbonate-based resin may be produced by: dissolving a polycarbonate oligomer produced through use of a dihydric phenol-based compound in advance to be described later, and a polyorganosiloxane in a water-insoluble organic solvent (e.g., methylene chloride); adding a solution of a dihydric phenol-based compound in an aqueous solution of an alkali compound (e.g., aqueous sodium hydroxide) to the solution; and subjecting the mixture to an interfacial polycondensation reaction through use of a tertiary amine (e.g., triethylamine) or a quaternary ammonium salt (e.g., trimethylbenzylammonium chloride) as a polymerization catalyst in the presence of a terminal stopper (a monohydric phenol such as p-tert-butylphenol) as required.

The polycarbonate oligomer may be produced by a reaction between a dihydric phenol-based compound and a carbonate precursor, such as phosgene or triphosgene, in an organic solvent, such as methylene chloride, chlorobenzene, or chloroform. When the polycarbonate oligomer is produced by using an ester exchange method, the oligomer may be produced by a reaction between the dihydric phenol-based compound and a carbonate precursor such as diphenyl carbonate.

A polyorganosiloxane represented by the following general formula (iii-i), the following general formula (iii-ii), and/or the following general formula (iii-iii) may be used as the polyorganosiloxane serving as a raw material:

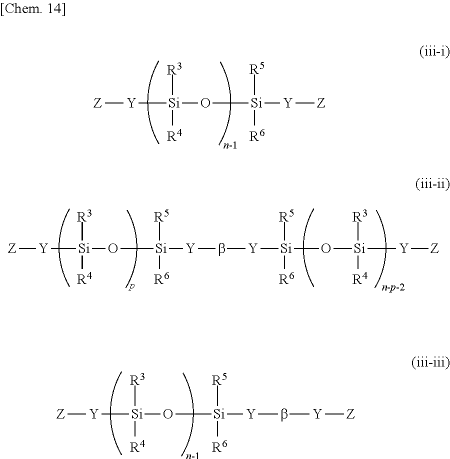

wherein R³ to R⁶, Y, β, “n” and “p” are as described above.

Specific examples of R³ to R⁶, Y, β, “n” and “p”, and preferred examples thereof are also as described above.

Z represents a hydrogen atom or a halogen atom, and a plurality of Zs may be identical to or different from each other.

Examples of the polyorganosiloxane represented by the general formula (iii-i) include compounds represented by the following general formulae (iii-i-1) to (iii-i-11):

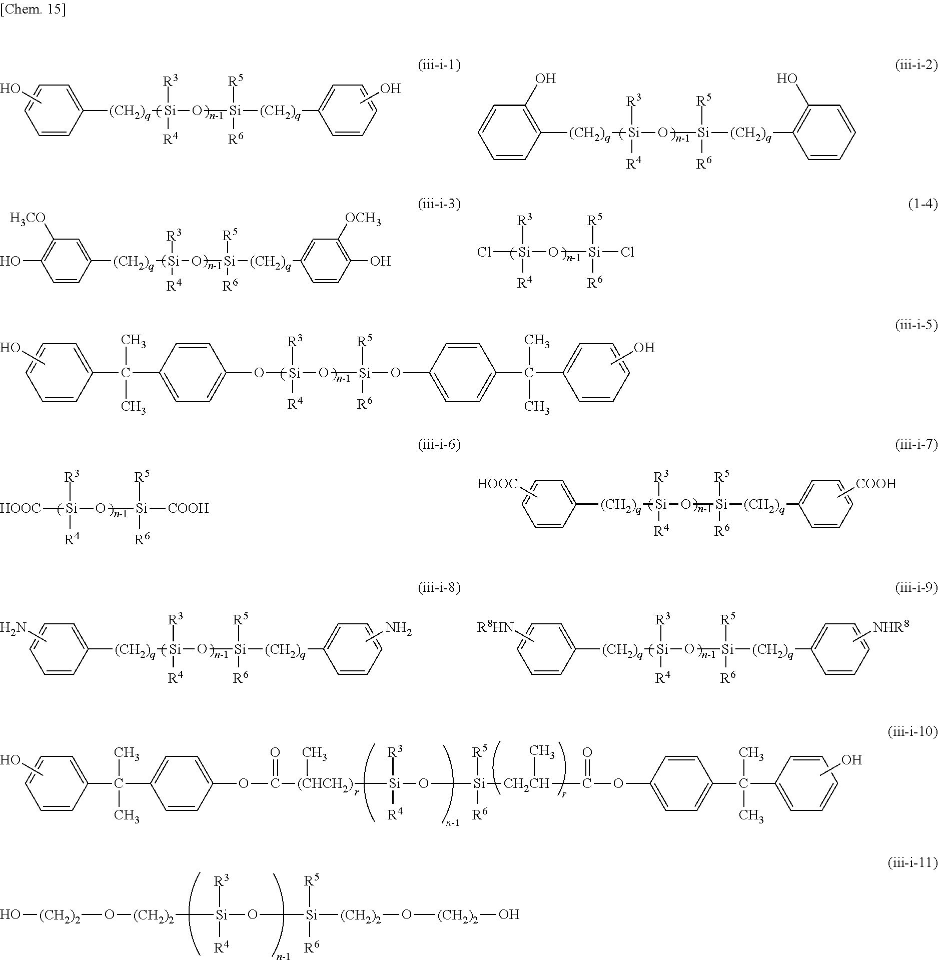

wherein in the general formulae (iii-i-1) to (iii-i-11), R³ to R⁶, n−1, and R⁸ are the same as those described above, and preferred examples thereof are also the same as those described above, and “q” and “r” each independently represent a positive integer, and each typically represent an integer of from 1 to 6.

Among them, a phenol-modified polyorganosiloxane represented by the general formula (iii-i-1) is preferred from the viewpoint of the ease with which the polyorganosiloxane is polymerized. In addition, an α,ω-bis [3-(o-hydroxyphenyl)propyl]polydimethylsiloxane, which is one kind of compound represented by the general formula (iii-i-2), or an α,ω-bis [3-(4-hydroxy-3-methoxyphenyl)propyl] polydimethylsiloxane, which is one kind of compound represented by the general formula (iii-i-3), is preferred from the viewpoint of ease of availability.

In addition to the foregoing, a compound including the following general formula (iii-iv) may be used as a polyorganosiloxane raw material:

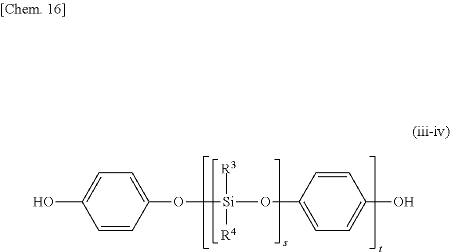

wherein R³, R⁴, “s”, and “t” are the same as those described above.

A method of producing the polyorganosiloxane is not particularly limited. According to, for example, a method described in JP 11-217390 A, a crude polyorganosiloxane may be obtained by: causing a cyclotrisiloxane and disiloxane to react with each other in the presence of an acidic catalyst to synthesize an α,ω-dihydrogen organopentasiloxane; and then subjecting the α,ω-dihydrogen organopentasiloxane to an addition reaction with, for example, a phenolic compound (e.g., 2-allylphenol, 4-allylphenol, eugenol, or 2-propenylphenol) in the presence of a catalyst for a hydrosilylation reaction. In addition, according to a method described in JP 2662310 B2, a crude polyorganosiloxane may be obtained by: causing octamethylcyclotetrasiloxane and tetramethyldisiloxane to react with each other in the presence of sulfuric acid (acidic catalyst); and subjecting the resultant α,ω-dihydrogen organopolysiloxane to an addition reaction with a phenolic compound or the like in the presence of a catalyst for a hydrosilylation reaction in the same manner as that described above. The α,ω-dihydrogen organopolysiloxane may be used after its chain length “n” has been appropriately adjusted by conditions for its polymerization, or a commercial α,ω-dihydrogen organopolysiloxane may be used. Specifically, a compound described in JP 2016-098292 A may be used.

The polycarbonate oligomer may be produced by a reaction between a dihydric phenol-based compound and a carbonate precursor, such as phosgene or triphosgene, in an organic solvent, such as methylene chloride, chlorobenzene, or chloroform. When the polycarbonate oligomer is produced by using an ester exchange method, the oligomer may be produced by a reaction between the dihydric phenol-based compound and a carbonate precursor such as diphenyl carbonate.

The dihydric phenol-based compound includes a dihydric phenol-based compound represented by the following formula (ii) from which the structural unit represented by the formula (II) is derived:

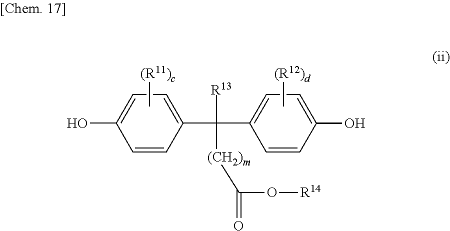

wherein in the formula (ii), R¹¹, R¹², R¹³, R¹⁴, “c”, “d”, and “m” are as defined above, and preferred examples thereof are also the same as those described above.

Preferred specific examples of the dihydric phenol-based compound represented by the formula (ii) include: cyclohexyl diphenolate represented by the following formula (ii-1); cyclopentyl diphenolate represented by the following formula (ii-2); cyclohexyl 2,2-bis(4-hydroxyphenyl) propanoate represented by the following formula (ii-3); methyl diphenolate represented by the following formula (ii-4); and methyl 2,2-bis(4-hydroxy-3-methylphenyl) propanoate represented by the following formula (ii-5).

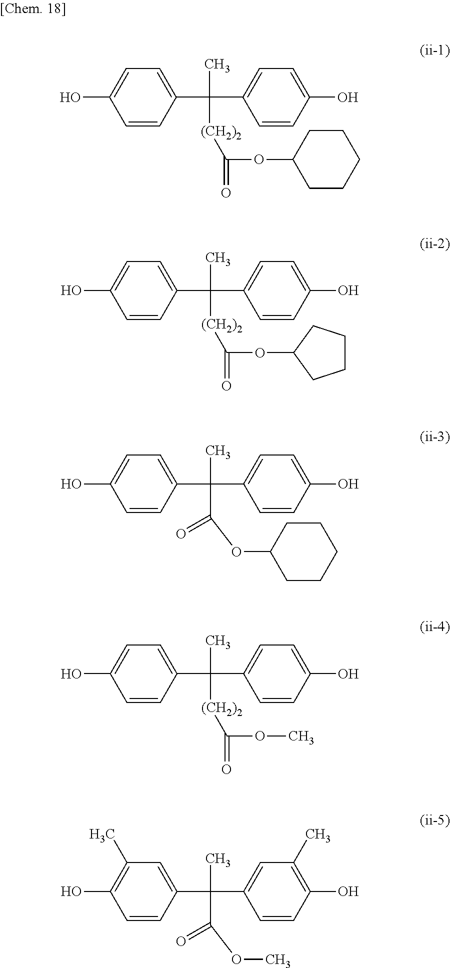

The dihydric phenol-based compound represented by the formula (ii) may be produced by, for example, causing a carboxylic acid compound represented by the following formula (ii-x) and an alcohol compound represented by the following formula (ii-y) to react with each other in the presence of an acid catalyst as required:

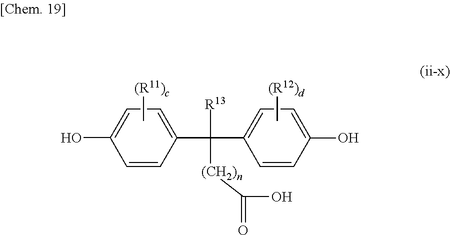

wherein in the formula (ii-x), R¹¹, R¹², R¹³, “c”, “d”, and “m” are as defined above, and preferred examples thereof are also the same as those described above;

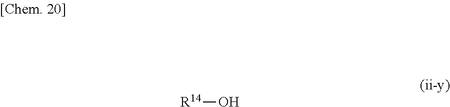

wherein in the formula (ii-y), R¹⁴ is as defined above, and preferred examples thereof are also the same as those described above.

The dihydric phenol-based compound preferably further includes a dihydric phenol-based compound represented by the following formula (i) from which the repeating unit represented by the formula (I) is derived:

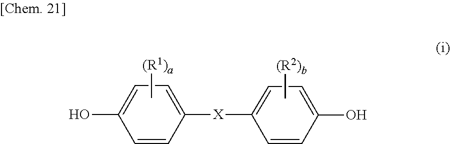

wherein in the formula (i), R¹, R², X, “a”, and “b” are as defined above, and preferred examples thereof are also the same as those described above.

Examples of the dihydric phenol-based compound represented by the formula (i) include: bis(hydroxyphenyl)alkane-based, such as 2,2-bis(4-hydroxyphenyl)propane [bisphenol A (BPA)], bis(4-hydroxyphenyl)methane, 1,1-bis(4-hydroxyphenyl)ethane, and 2,2-bis(4-hydroxy-3,5-dimethylphenyl)propane; 4,4′-dihydroxydiphenyl; bis(4-hydroxyphenyl)cycloalkanes; bis(4-hydroxyphenyl) oxide; bis(4-hydroxyphenyl) sulfide; bis(4-hydroxyphenyl) sulfone; bis(4-hydroxyphenyl) sulfoxide; and bis(4-hydroxyphenyl) ketone. Those dihydric phenol-based compounds may be used alone or as a mixture thereof.

Among them, bis(hydroxyphenyl)alkane-based dihydric phenols are preferred, and bisphenol A is more preferred.

In a preferred production method, only the dihydric phenol-based compound represented by the formula (i) may be used as a dihydric phenol-based compound for producing the above-mentioned polycarbonate oligomer. In this case, in the step of the interfacial polycondensation reaction, the dihydric phenol-based compound represented by the formula (ii) and the dihydric phenol-based compound represented by the formula (i) are used in combination, or only the dihydric phenol-based compound represented by the formula (ii) is used.

A terminal stopper (molecular weight modifier) may be used for adjusting the molecular weight of the PC-POS copolymer to be obtained. Examples of the terminal stopper may include monohydric phenols, such as phenol, p-cresol, p-tert-butylphenol, p-tert-octylphenol, p-cumylphenol, p-nonylphenol, m-pentadecylphenol, and p-tert-amylphenol. Those monohydric phenols may be used alone or in combination thereof.

The PC-POS copolymer of the present invention can improve the scratch resistance of a molded article thereof, and hence may be suitably used in a scratch-resistant application.

### 3. Resin Composition

The resin composition of the present invention includes the above-mentioned PC-POS copolymer, and as required, any other component.

Examples of the other component may include additives, such as a hydrolysis-resistant agent, an antioxidant, a UV absorber, a flame retardant, a flame retardant aid, a reinforcing material, a filler, an elastomer for an impact resistance improvement, a pigment, and a dye.

The resin composition may include an antioxidant from, for example, the viewpoint that its oxidative deterioration at the time of melting can be prevented, and hence its coloring or the like due to the oxidative deterioration is prevented.

The content of the antioxidant is preferably from 0.001 part by mass to 0.5 part by mass, more preferably from 0.01 part by mass to 0.3 part by mass, still more preferably from 0.02 part by mass to 0.2 part by mass with respect to 100 parts by mass of the content of the resin composition. When the content of the antioxidant falls within the above-mentioned ranges, a sufficient antioxidant action is obtained, and mold contamination at the time of the molding can be suppressed.

A method of producing the resin composition of the present invention is not particularly limited as long as the method includes a step of mixing the above-mentioned PC-POS copolymer and any other optional component. The resin composition may be produced by, for example, mixing the above-mentioned PC-POS copolymer and any other optional component with a mixer or the like, and melting and kneading the mixture. The melting and kneading may be performed by a typically used method such as a method including using, for example, a ribbon blender, a Henschel mixer, a Banbury mixer, a drum tumbler, a single-screw extruder, a twin-screw extruder, a co-kneader, or a multi-screw extruder. A heating temperature at the time of the melting and kneading is appropriately selected from the range of, for example, from 150° C. to 300° C., preferably from about 220° C. to about 300° C.

The resin composition of the present invention can improve the scratch resistance of a molded article thereof, and hence may be suitably used in a scratch-resistant application.

The scratch-resistant application is, for example, a structural body whose outer surface is formed of the above-mentioned resin composition, and more specific examples thereof include a resin window, a touch panel, an interior supply, an exterior supply, an interior part or an exterior part of a vehicle, a casing, an electric appliance, a building material, and OA equipment. The resin composition of the present invention may be suitably used for producing the above-mentioned articles.

### 4. Molded Article

The molded article of the present invention includes the above-mentioned resin composition. The molded article may be produced through use of a melt-kneaded product of the resin composition or a pellet thereof obtained through melting and kneading as a raw material by an injection molding method, an injection compression molding method, an extrusion molding method, a blow molding method, a press molding method, a vacuum molding method, an expansion molding method, or the like. In particular, the molded article is preferably produced through use of a pellet obtained through melting and kneading by an injection molding method or an injection compression molding method.

The thickness of the molded article may be arbitrarily set in accordance with applications, and particularly when the transparency of the molded article is required, the thickness is preferably from 0.2 mm to 4.0 mm, more preferably from 0.3 mm to 3.0 mm, still more preferably from 0.3 mm to 2.0 mm. When the thickness of the molded article is 0.2 mm or more, no warping occurs, and hence satisfactory mechanical strength is obtained. In addition, when the thickness of the molded article is 4.0 mm or less, high transparency is obtained.

The molded article formed of the resin composition of the present invention may be suitably used as, for example, a resin window, a touch panel, an interior supply, an exterior supply, an interior part or an exterior part of a vehicle, a casing, an electric appliance part, a building material, or an OA equipment part.

### EXAMPLES

Examples of the present invention are further described. The present invention is by no means limited by these examples. Measurement and evaluations in the respective examples were performed by the following methods.

### 1. Measurement of Viscosity-Average Molecular Weight (Mv)

A viscosity-average molecular weight (Mv) was calculated from the following equation (Schnell's equation) after the determination of a limiting viscosity [η] through the measurement of the viscosity of a methylene chloride solution (concentration: g/L) at 20° C. with an Ubbelohde-type viscometer.

$$[ η ] = 1.23 \times 1 {0}^{- 5} {Mv}^{0.83}$$

### 2. Conditions for ¹H-NMR Measurement

NMR apparatus: “ECA-500” manufactured by JEOL RESONANCE Co., Ltd.
Probe: 50TH5AT/FG2
Measurement nucleus: ¹H
Observation range: from −5 ppm to 15 ppm
Observation center: 5 ppm
Pulse repetition time: 9 seconds
Pulse width: 45°
NMR sample tube: 5φ
Sample amount: from 30 mg to 40 mg
Solvent: deuterochloroform
Solvent amount: 0.4 mL
Measurement temperature: room temperature
Number of scans: 256 times

Chemical shift correction: the peak of a methyl group derived from bisphenol A in a sample is set to a reference of 1.68 ppm.

### 3. Determination of Composition of PC-POS Copolymer

The ¹H-NMR measurement of a PC-POS copolymer was performed under the foregoing measurement conditions, and the structure of the PC-POS copolymer was assigned.

### Synthesis Example 1 (Synthesis of Cyclohexyl Diphenolate)

620 Milliliters of cyclohexanol, 111 g (388 mmol) of diphenolic acid, and 5.69 g (58.0 mmol) of sulfuric acid were loaded into a 1-liter flask to provide a reaction liquid, and a stirrer chip, a temperature gauge, and a reflux tube were set therein. The temperature of the reaction liquid was increased to 80° C. with an oil bath, and the liquid was stirred with a magnetic stirrer for 19 hours. The disappearance of diphenolic acid was recognized by thin-layer chromatography (TLC), and then the temperature of the reaction liquid was returned to room temperature. 600 Milliliters of toluene was loaded into the reaction liquid, and the mixture was washed with 800 mL of baking soda water (saturated aqueous solution of sodium hydrogen carbonate) twice and with 800 mL of brine (saturated salt solution) once. The organic phase was dried with anhydrous sodium sulfate, and was then concentrated under reduced pressure to provide 316 g of a pale brown liquid as a crude product. The resultant crude product was purified with a silica gel column (neutral silica gel: 1.05 kg, solvent: heptane/ethyl acetate=4/1) to provide 263 g of a pale yellow liquid. The resultant pale yellow liquid was subjected to azeotropy with a mixed solvent containing acetonitrile and water at 2:1 (300 g) eight times. The precipitated solid was recovered by filtration under reduced pressure, and was subjected to suspension washing with 500 mL of hexane twice. The resultant solid was dried under reduced pressure at 40° C. for 12 hours to provide 113 g of a white solid of cyclohexyl diphenolate.

### Synthesis Example 2 (Synthesis of Cyclopentyl Diphenolate)

694 Milliliters of cyclopentanol, 124 g (434 mmol) of diphenolic acid, and 6.37 g (65.0 mmol) of sulfuric acid were loaded into a 1-liter flask to provide a reaction liquid, and a stirrer chip, a temperature gauge, and a reflux tube were set therein. The temperature of the reaction liquid was increased to 80° C. with an oil bath, and the liquid was stirred with a magnetic stirrer for 19 hours. The disappearance of diphenolic acid was recognized by thin-layer chromatography (TLC), and then the temperature of the reaction liquid was returned to room temperature. 600 Milliliters of toluene was loaded into the reaction liquid, and the mixture was washed with 600 mL of baking soda water (saturated aqueous solution of sodium hydrogen carbonate) twice and with 600 mL of brine (saturated salt solution) once. The organic phase was dried with anhydrous sodium sulfate, and was then concentrated under reduced pressure to provide 172 g of a pale brown liquid as a crude product. The resultant crude product was dissolved in a mixture (350 g) containing hexane and ethyl acetate at 9:1, and the solution was left at room temperature overnight. The precipitated solid was recovered by filtration under reduced pressure, and was dried under reduced pressure at 40° C. for 12 hours to provide a white solid (55.3 g) of cyclopentyl diphenolate. The filtrate was left at rest at 4° C. overnight, and the precipitated solid was recovered by filtration under reduced pressure. The recovered solid was dried under reduced pressure at 40° C. for 12 hours to provide a white solid (38.5 g) of cyclopentyl diphenolate. The filtrate was concentrated under reduced pressure, and the resultant liquid was dissolved in chloroform (100 g). Toluene (180 g) was added to the solution, and the mixture was left at 4° C. overnight. The precipitated solid was recovered by filtration under reduced pressure, and was subjected to suspension washing with hexane twice. The washed solid was dried under reduced pressure at 50° C. for 12 hours to provide a white solid (14.4 g) of cyclopentyl diphenolate. A total of 108.2 g of cyclopentyl diphenolate was obtained.

### Synthesis Example 3 (Synthesis of Cyclohexyl 2,2-Bis(4-hydroxyphenyl)propanoate)

Phenol (131 g, 1.39 mol), pyruvic acid (60.3 g, 0.68 mol), and ion-exchanged water (45.6 g) were loaded into a 1-liter four-necked flask, and a stirrer chip and a temperature gauge were set therein. The flask was cooled with ice, and 95% sulfuric acid (112 g, 1.14 mol) was dropped thereinto over 50 minutes. After that, the temperature of the reaction liquid was increased to room temperature, and the liquid was stirred for 14 hours. Diethyl ether (1 L) was loaded into the reaction liquid, and the mixture was washed with ion-exchanged water (1 L) once. The organic layer was extracted with 0.1 M aqueous sodium hydroxide (1 L) twice. The pH of the extract was adjusted to 2 with 1 M hydrochloric acid, and the extract was extracted with diethyl ether (1 L) twice. The extract was dried with sodium sulfate, and was then dried under reduced pressure to provide a pale brown solid (139 g). The pale brown solid (130 g), cyclohexanol (2.01 L), and 95% sulfuric acid (27.7 g, 0.28 mol) were loaded into a 5-liter four-necked flask, and a stirring blade, a temperature gauge, and a reflux tube were set therein. After that, the temperature of the reaction liquid was increased to 100° C., and the liquid was stirred for 15 days. The reaction liquid was diluted twofold with diethyl ether, and was washed with baking soda water twice, with water once, and with brine once. The organic layer was dried with magnesium sulfate, and was concentrated under reduced pressure to provide a crude product (815 g). The crude product was purified with a silica gel column (neutral silica gel: 5.0 kg, solvent: chloroform/ethyl acetate=1/0→0/1) three times. After that, the purified product was dissolved in a solution containing chloroform and ethyl acetate at 1:1, and the solution was subjected to a recrystallization operation to provide a white solid (52.9 g) of cyclohexyl 2,2-bis(4-hydroxyphenyl) propanoate.

### Synthesis Example 4 (Synthesis of Methyl Diphenolate)

500 Milliliters of methanol, 50 g (175 mmol) of diphenolic acid, and 2.5 mL of sulfuric acid were loaded into a 1-liter flask, and a stirrer chip, a temperature gauge, and a reflux tube were set therein. The temperature of the reaction liquid was increased to 70° C. with an oil bath, and the liquid was stirred with a magnetic stirrer for 5 hours. The temperature of the reaction liquid was returned to room temperature, and then the liquid was concentrated under reduced pressure. Ethyl acetate was loaded into the reaction liquid, and the mixture was washed with 100 mL of baking soda water three times and with 100 mL of water twice. The solution was concentrated under reduced pressure to provide 55.3 g of a colorless solid as a crude product. The resultant crude product and 100 mL of toluene were loaded into a 200-milliliter flask, and a stirrer chip, a temperature gauge, and a reflux tube were set therein. The temperature of the reaction liquid was increased with the oil bath until toluene refluxed, followed by complete dissolution of the crude product in toluene. After that, the solution was left standing to cool to room temperature, and the precipitated solid was recovered by filtration under reduced pressure. The recovered solid was dissolved in 100 mL of toluene again, and the same operation was repeated. Thus, 32.7 g of a white solid of methyl diphenolate was obtained.

### Synthesis Example 5 (Synthesis of Methyl 2,2-Bis (4-hydroxy-3-methylphenyl)propanoate)

Methyl 2,2-bis(4-hydroxy-3-methylphenyl) propanoate was produced in the same manner as in Synthesis Example 3 except that: phenol was changed to o-cresol; and cyclohexanol was changed to methanol.

### Production Example 1: Production of Polycarbonate-Polyorganosiloxane Copolymer (1) (PC-POS Copolymer 1)

### (Synthesis of Polycarbonate Oligomer 1)

Sodium dithionite (Na₂S₂O₄) was added to 5.6 mass % aqueous sodium hydroxide so that its concentration became 2,000 ppm with respect to bisphenol A (BPA) to be dissolved later. BPA was dissolved therein so that the concentration of BPA became 13.5 mass %. Thus, a solution of BPA in aqueous sodium hydroxide was prepared.

The solution of BPA in aqueous sodium hydroxide, methylene chloride, and phosgene were continuously passed through a tubular reactor having an inner diameter of 6 mm and a tube length of 30 m at flow rates of 40 L/hr, 13 L/hr, and 4.5 kg/hr, respectively. The tubular reactor had a jacket portion and the temperature of the reaction liquid was kept at 40° C. or less by passing cooling water through the jacket. An aqueous phase was separated and removed by continuously taking out the reaction liquid that had exited the tubular reactor and leaving the reaction liquid at rest. Then, a methylene chloride phase was collected.

The polycarbonate oligomer thus obtained had a concentration of 301 g/L and a chloroformate group concentration of 1.03 mol/L.

### (Production of PC-POS Copolymer 1)

(i) Milliliters of the polycarbonate oligomer solution (PCO) produced in Production Example 1 described above, (ii) mL of methylene chloride, (iii) g of cyclohexyl diphenolate obtained in Synthesis Example 1 described above, (v) g of an o-allylphenol terminal-modified polydimethylsiloxane (PDMS) in which the average chain length “n” of its polydimethylsiloxane was (iv), and (vi) μL of triethylamine (TEA) were loaded into a 1-liter separable flask mounted with a baffle board. Aqueous sodium hydroxide (obtained by dissolving (vii) g of sodium hydroxide in (viii) mL of pure water) was added to the mixture under stirring to perform a reaction for 20 minutes. Thus, a polymerization liquid was obtained.

A solution of p-tert-butylphenol (PTBP) in methylene chloride (obtained by dissolving (ix) g of PTBP in (x) mL of methylene chloride) and a solution of bisphenol A (BPA) in aqueous sodium hydroxide (obtained by dissolving (xiv) g of BPA in an aqueous solution obtained by dissolving (xi) g of sodium hydroxide and (xii) mg of sodium dithionite in (xiii) mL of pure water) were added to the polymerization liquid, and the mixture was subjected to a polymerization reaction for 40 minutes.

(xv) Milliliters of methylene chloride was added for diluting the resultant, and the mixture was stirred for 10 minutes. After that, the mixture was separated into an organic phase containing a PC-POS copolymer 1, and an aqueous phase containing excess amounts of BPA and sodium hydroxide, and the organic phase was isolated. The solution of the PC-POS copolymer 1 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the PC-POS copolymer 1 was obtained as a white product.

The amounts of the respective components (i) to (xv) are as shown in Table 1.

The contents of the repeating unit represented by the formula (I), the structural unit represented by the formula (II), and the repeating unit represented by the formula (III) in the PC-POS copolymer 1, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weight (Mv) of the PC-POS copolymer 1 were measured by the above-mentioned evaluation methods. The results are shown in Table 2.

### Production Examples 2 to 12 (Production of PC-POS Copolymers 2 to 12)

PC-POS copolymers 2 to 12 were each produced in the same manner as in Production Example 1 except that the amounts of the respective components (i) to (xv) were changed as shown in Table 1.

The contents of the repeating unit represented by the formula (I), the structural unit represented by the formula (II), and the repeating unit represented by the formula (III) in each of the PC-POS copolymers 2 to 13, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weights (Mv) of the PC-POS copolymers 2 to 12 were measured in the same manner as in the PC-POS copolymer 1. The results are shown in Table 2.

### Production Example 13 (Production of PC-POS Copolymer 13)

63 Milliliters of the polycarbonate oligomer solution produced in Production Example 1 described above, 21 mL of methylene chloride, 2.46 g of cyclohexyl 2,2-bis(4-hydroxyphenyl) propanoate produced in Synthesis Example 3 described above, 0.5 g of an o-length “n” of its polydimethylsiloxane was 37, and 44 μL of triethylamine (TEA) were loaded into a 300-milliliter separable flask mounted with a baffle board. Aqueous sodium hydroxide (obtained by dissolving 0.9 g of sodium hydroxide in 10.5 mL of pure water) was added to the mixture under stirring to perform a reaction for 20 minutes. Thus, a polymerization liquid was obtained.

A solution of p-tert-butylphenol (PTBP) in methylene chloride (obtained by dissolving 0.37 g of PTBP in 2.5 mL of methylene chloride) and a solution of BPA in aqueous sodium hydroxide (obtained by dissolving 4.6 g of BPA in an aqueous solution obtained by dissolving 2.3 g of sodium hydroxide and 9 mg of sodium dithionite in 34 mL of pure water) were added to the polymerization liquid, and the mixture was subjected to a polymerization reaction for 40 minutes.

100 Milliliters of methylene chloride was added for diluting the resultant, and the mixture was stirred for 10 minutes. After that, the mixture was separated into an organic phase containing a PC-POS copolymer 13, and an aqueous phase containing excess amounts of BPA and sodium hydroxide, and the organic phase was isolated. The solution of the PC-POS copolymer 13 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the PC-POS copolymer 13 was obtained as a white product.

The contents of the repeating unit represented by the formula (I), the structural unit represented by the formula (II), and the repeating unit represented by the formula (III) in the PC-POS copolymer 13, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weight (Mv) of the PC-POS copolymer 13 were measured in the same manner as in the PC-POS copolymer 1. The results are shown in Table 2.

### Production Example 14 (Production of PC-POS Copolymer 14)

44 Milliliters of the polycarbonate oligomer solution produced in Production Example 1 described above, 34 mL of methylene chloride, 2.25 g of cyclopentyl diphenolate produced in Synthesis Example 2 described above, 0.5 g of an o-allylphenol terminal-modified polydimethylsiloxane (PDMS) in which the average chain length “n” of its polydimethylsiloxane was 37, and 34 μL of triethylamine (TEA) were loaded into a 300-milliliter separable flask mounted with a baffle board. Aqueous sodium hydroxide (obtained by dissolving 0.6 g of sodium hydroxide in 7.3 mL of pure water) was added to the mixture under stirring to perform a reaction for 20 minutes. Thus, a polymerization liquid was obtained.

A solution of p-tert-butylphenol (PTBP) in methylene chloride (obtained by dissolving 0.33 g of PTBP in 2.3 mL of methylene chloride) and a solution of BPA in aqueous sodium hydroxide (obtained by dissolving 3.6 g of BPA in an aqueous solution obtained by dissolving 1.9 g of sodium hydroxide and 7 mg of sodium dithionite in 28 mL of pure water) were added to the polymerization liquid, and the mixture was subjected to a polymerization reaction for 40 minutes.

90 Milliliters of methylene chloride was added for diluting the resultant, and the mixture was stirred for 10 minutes. After that, the mixture was separated into an organic phase containing a PC-POS copolymer 14, and an aqueous phase containing excess amounts of BPA and sodium hydroxide, and the organic phase was isolated. The solution of the PC-POS copolymer 14 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the PC-POS copolymer 14 was obtained as a white product.

The contents of the repeating unit represented by the formula (I), the structural unit represented by the formula (II), and the repeating unit represented by the formula (III) in the PC-POS copolymer 14, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weight (Mv) of the PC-POS copolymer 14 were measured in the same manner as in the PC-POS copolymer 1. The results are shown in Table 2.

### Production Example 15 (Production of PC-POS Copolymer 15)

58 Milliliters of the polycarbonate oligomer solution produced in Production Example 1 described above, 82 mL of methylene chloride, 2.25 g of methyl 2,2-bis(4-hydroxy-3-methylphenyl) propanoate produced in Synthesis Example 5 described above, 0.5 g of an o-length “n” of its polydimethylsiloxane was 37, and 41 μL of triethylamine (TEA) were loaded into a 300-milliliter separable flask mounted with a baffle board. Aqueous sodium hydroxide (obtained by dissolving 0.9 g of sodium hydroxide in 9.8 mL of pure water) was added to the mixture under stirring to perform a reaction for 20 minutes. Thus, a polymerization liquid was obtained.

A solution of p-tert-butylphenol (PTBP) in methylene chloride (obtained by dissolving 0.35 g of PTBP in 2.5 mL of methylene chloride) and a solution of BPA in aqueous sodium hydroxide (obtained by dissolving 4.3 g of BPA in an aqueous solution obtained by dissolving 2.2 g of sodium hydroxide and 9 mg of sodium dithionite in 32 mL of pure water) were added to the polymerization liquid, and the mixture was subjected to a polymerization reaction for 40 minutes.

30 Milliliters of methylene chloride was added for diluting the resultant, and the mixture was stirred for 10 minutes. After that, the mixture was separated into an organic phase containing a PC-POS copolymer 15, and an aqueous phase containing excess amounts of BPA and sodium hydroxide, and the organic phase was isolated. The solution of the PC-POS copolymer 15 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the PC-POS copolymer 15 was obtained as a white product.

The contents of the repeating unit represented by the formula (I), the structural unit represented by the formula (II), and the repeating unit represented by the formula (III) in the PC-POS copolymer 15, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weight (Mv) of the PC-POS copolymer 15 were measured in the same manner as in the PC-POS copolymer 1. The results are shown in Table 2.

### Production Example 16 (Production of PC-POS Copolymer 16)

58 Milliliters of the polycarbonate oligomer solution produced in Production Example 1 described above, 19 mL of methylene chloride, 2.3 g of methyl 2,2-bis(4-hydroxy-3-methylphenyl)propanoate produced in Synthesis Example 5 described above, 0.5 g of an o-length “n” of its polydimethylsiloxane was 37, and 41 μL of triethylamine (TEA) were loaded into a 300-milliliter separable flask mounted with a baffle board. Aqueous sodium hydroxide (obtained by dissolving 0.8 g of sodium hydroxide in 8.7 mL of pure water) was added to the mixture under stirring to perform a reaction for 20 minutes. Thus, a polymerization liquid was obtained.

A solution of p-tert-butylphenol (PTBP) in methylene chloride (obtained by dissolving 0.33 g of PTBP in 2.3 mL of methylene chloride) and a solution of BPA in aqueous sodium hydroxide (obtained by dissolving 4.3 g of BPA in an aqueous solution obtained by dissolving 2.3 g of sodium hydroxide and 9 mg of sodium dithionite in 33 mL of pure water) were added to the polymerization liquid, and the mixture was subjected to a polymerization reaction for 40 minutes.

90 Milliliters of methylene chloride was added for diluting the resultant, and the mixture was stirred for 10 minutes. After that, the mixture was separated into an organic phase containing a PC-POS copolymer 16, and an aqueous phase containing excess amounts of BPA and sodium hydroxide, and the organic phase was isolated. The solution of the PC-POS copolymer 16 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the PC-POS copolymer 16 was obtained as a white product.

The contents of the repeating unit represented by the formula (I), the structural unit represented by the formula (II), and the repeating unit represented by the formula (III) in the PC-POS copolymer 16, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weight (Mv) of the PC-POS copolymer 16 were measured in the same manner as in the PC-POS copolymer 1. The results are shown in Table 2.

### Production Example 17 (Production of PC-POS Copolymer 17)

44 Milliliters of the polycarbonate oligomer solution produced in Production Example 1 described above, 34 mL of methylene chloride, 2.25 g of methyl 2,2-bis(4-hydroxy-3-methylphenyl)propanoate produced in Synthesis Example 5 described above, 0.5 g of an o-length “n” of its polydimethylsiloxane was 37, and 34 μL of triethylamine (TEA) were loaded into a 300-milliliter separable flask mounted with a baffle board. Aqueous sodium hydroxide (obtained by dissolving 0.6 g of sodium hydroxide in 7.3 mL of pure water) was added to the mixture under stirring to perform a reaction for 20 minutes. Thus, a polymerization liquid was obtained.

A solution of p-tert-butylphenol (PTBP) in methylene chloride (obtained by dissolving 0.33 g of PTBP in 2.3 mL of methylene chloride) and a solution of BPA in aqueous sodium hydroxide (obtained by dissolving 3.6 g of BPA in an aqueous solution obtained by dissolving 1.9 g of sodium hydroxide and 7 mg of sodium dithionite in 28 mL of pure water) were added to the polymerization liquid, and the mixture was subjected to a polymerization reaction for 40 minutes.

90 Milliliters of methylene chloride was added for diluting the resultant, and the mixture was stirred for 10 minutes. After that, the mixture was separated into an organic phase containing a PC-POS copolymer 17, and an aqueous phase containing excess amounts of BPA and sodium hydroxide, and the organic phase was isolated. The solution of the PC-POS copolymer 17 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the PC-POS copolymer 17 was obtained as a white product.

The contents of the repeating unit represented by the formula (I), the structural unit represented by the formula (II), and the repeating unit represented by the formula (III) in the PC-POS copolymer 17, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weight (Mv) of the PC-POS copolymer 17 were measured in the same manner as in the PC-POS copolymer 1. The results are shown in Table 2.

### Production Example 18 (Production of PC-POS Copolymer 18)

50 Milliliters of the polycarbonate oligomer solution produced in Production Example 1 described above, 70 mL of methylene chloride, 1.95 g of methyl diphenolate produced in Synthesis Example 4 described above, 0.4 g of an o-allylphenol terminal-modified polydimethylsiloxane (PDMS) in which the average chain length “n” of its polydimethylsiloxane was 37, 0.28 g of p-tert-butylphenol (PTBP), and 35 μL of triethylamine (TEA) were loaded into a 300-milliliter separable flask mounted with a baffle board. Aqueous sodium hydroxide (obtained by dissolving 0.6 g of sodium hydroxide in 7.5 mL of pure water) was added to the mixture under stirring to perform a reaction for 20 minutes. Thus, a polymerization liquid was obtained.

A solution of BPA in aqueous sodium hydroxide (obtained by dissolving 3.7 g of BPA in an aqueous solution obtained by dissolving 1.6 g of sodium hydroxide and 7 mg of sodium dithionite in 24 mL of pure water) was added to the polymerization liquid, and the mixture was subjected to a polymerization reaction for 40 minutes.

50 Milliliters of methylene chloride was added for diluting the resultant, and the mixture was stirred for 10 minutes. After that, the mixture was separated into an organic phase containing a PC-POS copolymer 18, and an aqueous phase containing excess amounts of BPA and sodium hydroxide, and the organic phase was isolated. The solution of the PC-POS copolymer 18 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the PC-POS copolymer 18 was obtained as a white product.

The contents of the repeating unit represented by the formula (I), the structural unit represented by the formula (II), and the repeating unit represented by the formula (III) in the PC-POS copolymer 18, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weight (Mv) of the PC-POS copolymer 18 were measured in the same manner as in the PC-POS copolymer 1. The results are shown in Table 2.

### Comparative Production Example 1 (Production of PC-POS Copolymer 21)

### (Synthesis of Polycarbonate Oligomer 2)

Sodium dithionite was added to 5.6 mass % aqueous sodium hydroxide so that its concentration became 2,000 ppm with respect to bisphenol A (BPA) to be dissolved later. BPA was dissolved therein so that the concentration of BPA became 13.5 mass %. Thus, a solution of BPA in aqueous sodium hydroxide was prepared.

The solution of BPA in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion and the temperature of the reaction liquid was kept at 40° C. or less by passing cooling water through the jacket. The reaction liquid that had exited the tubular reactor was continuously introduced into a baffled vessel-type reactor including a sweptback blade and having an internal value of 40 L. The solution of BPA in aqueous sodium hydroxide, 25 mass % aqueous sodium hydroxide, water, and a 1 mass % aqueous solution of triethylamine were further added at flow rates of 2.8 L/hr, 0.07 L/hr, 17 L/hr, and 0.64 L/hr, respectively to the reactor to perform a reaction. An aqueous phase was separated and removed by continuously taking out the reaction liquid overflowing the vessel-type reactor, and leaving the liquid at rest. Then, a methylene chloride phase was collected.

The polycarbonate oligomer thus obtained had a concentration of 341 g/L and a chloroformate group concentration of 0.71 mol/L.

### (Production of PC-POS Copolymer 21)

15 Liters of the polycarbonate oligomer solution (PCO) produced in Production Example 2 described above, 8.6 L of methylene chloride, a solution, which was obtained by dissolving 400 g of an o-allylphenol terminal-modified polydimethylsiloxane (PDMS) in which the average chain length “n” of its polydimethylsiloxane was 37 in 2 L of methylene chloride, and 11.2 mL of triethylamine (TEA) were loaded into a 50-liter vessel-type reactor including a baffle board, a paddle-type stirring blade, and a cooling jacket. Aqueous sodium hydroxide (obtained by dissolving 170 g of sodium hydroxide in 2 L of pure water) was added to the mixture under stirring to perform a reaction between the polycarbonate oligomer and the allylphenol terminal-modified PDMS for 20 minutes.

A solution of p-tert-butylphenol (PTBP) in methylene chloride (obtained by dissolving 112.5 g of PTBP in 0.5 L of methylene chloride) and a solution of bisphenol A in aqueous sodium hydroxide (obtained by dissolving 826 g of bisphenol A in an aqueous solution obtained by dissolving 562 g of sodium hydroxide and 1.7 g of sodium dithionite in 8.2 L of pure water) were added to the polymerization liquid, and the mixture was subjected to a polymerization reaction for 40 minutes.

8 Liters of methylene chloride was added for diluting the resultant, and the mixture was stirred for 20 minutes. After that, the mixture was separated into an organic phase containing a polycarbonate-polydimethylsiloxane copolymer (PC-POS copolymer 21), and an aqueous phase containing excess amounts of bisphenol A and sodium hydroxide, and the organic phase was isolated.

The solution of the PC-POS copolymer 21 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less.

The solution of the PC-POS copolymer 21 in methylene chloride obtained by the washing was concentrated and pulverized, and the resultant flake was dried under reduced pressure at 120° C. to produce the PC-POS copolymer 21.

The contents of the repeating unit represented by the formula (I), the structural unit represented by the formula (II), and the repeating unit represented by the formula (III) in the PC-POS copolymer 21, the average number of repetitions of the polyorganosiloxane block (A-2) therein, and the viscosity-average molecular weight (Mv) of the PC-POS copolymer 21 were measured in the same manner as in the PC-POS copolymer 1. The results are shown in Table 2.

### Comparative Production Example 2 (Production of PC-POS Copolymer 22)

15 Liters of the polycarbonate oligomer solution (PCO) produced in Production Example 2 described above, 8.6 L of methylene chloride, a solution, which was obtained by dissolving 400 g of an o-allylphenol terminal-modified polydimethylsiloxane (PDMS) in which the average chain length “n” of its polydimethylsiloxane was 90 in 2 L of methylene chloride, and 8.3 mL of triethylamine (TEA) were loaded into a 50-liter vessel-type reactor including a baffle board, a paddle-type stirring blade, and a cooling jacket. Aqueous sodium hydroxide (obtained by dissolving 84 g of sodium hydroxide in 2 L of pure water) was added to the mixture under stirring to perform a reaction between the polycarbonate oligomer and the allylphenol terminal-modified PDMS for 20 minutes.

A solution of p-tert-butylphenol (PTBP) in methylene chloride (obtained by dissolving 146.8 g of PTBP in 0.5 L of methylene chloride) and a solution of bisphenol A in aqueous sodium hydroxide (obtained by dissolving 1,044 g of bisphenol A in an aqueous solution obtained by dissolving 554 g of sodium hydroxide and 2.1 g of sodium dithionite in 8.1 L of pure water) were added to the polymerization liquid, and the mixture was subjected to a polymerization reaction for 40 minutes.

13 Liters of methylene chloride was added for diluting the resultant, and the mixture was stirred for 20 minutes. After that, the mixture was separated into an organic phase containing a polycarbonate-polydimethylsiloxane copolymer (PC-POS copolymer 22), and an aqueous phase containing excess amounts of bisphenol A and sodium hydroxide, and the organic phase was isolated.

The solution of the PC-POS copolymer 22 in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less.

The solution of the PC-POS copolymer 22 in methylene chloride obtained by the washing was concentrated and pulverized, and the resultant flake was dried under reduced pressure at 120° C. to produce the PC-POS copolymer 22.

The contents of the repeating unit represented by the formula (I), the structural unit represented by the formula (II), and the repeating unit represented by the formula (III) in the PC-POS copolymer 22, the average number of repetitions of the polyorganosiloxane block (A-2) therein, and the viscosity-average molecular weight (Mv) of the PC-POS copolymer 22 were measured in the same manner as in the PC-POS copolymer 1. The results are shown in Table 2.

### Comparative Production Examples 3 and 4 (Production of PC-POS Copolymers 23 and 24)

PC-POS copolymers 23 and 24 were each produced in the same manner as in Production Example 1 except that the amounts of the respective components (i) to (xv) were changed as shown in Table 1.

The contents of the repeating unit represented by the formula (I), the structural unit represented by the formula (II), and the repeating unit represented by the formula (III) in each of the PC-POS copolymers 23 and 24, the content of the structural unit represented by the formula (II) with respect to the total of the structural unit represented by the formula (II) and the repeating unit represented by the formula (III) therein, the average number of repetitions of the polyorganosiloxane block (A-2) therein, and the viscosity-average molecular weights (Mv) of the PC-POS copolymers 23 and 24 were measured in the same manner as in the PC-POS copolymer 1. The results are shown in Table 2.

TABLE 1

| | | | Production Example | | | | | | |
|---|---|---|---|---|---|---|---|---|---|
| | | | 1 | 2 | 3 | 4 | 5 | 6 | 7 |
| PC-POS copolymer | | | 1 | 2 | 3 | 4 | 5 | 6 | 7 |
| Production | (i) PCO | mL | 266 | 255 | 255 | 255 | 255 | 238 | 238 |
| condition | (ii) Methylene chloride | mL | 168 | 161 | 161 | 161 | 161 | 151 | 151 |
| | (iii) Cyclohexyl diphenolate | g | 12.6 | 12.5 | 16.0 | 16.0 | 16.5 | 19.2 | 22.3 |
| | (iv) Average chain length of | — | 37 | 37 | 37 | 37 | 37 | 37 | 37 |
| | POS | | | | | | | | |
| | (v) PDMS | g | 2.8 | 2.6 | 2.8 | 4.4 | 6.8 | 6.5 | 9.0 |
| | (vi) TEA | mL | 186 | 178 | 178 | 178 | 178 | 166 | 166 |
| | (vii) NaOH | g | 3.4 | 3.7 | 3.3 | 3.3 | 3.3 | 3.1 | 3.1 |
| | (viii) Pure water | mL | 40 | 49 | 44 | 38 | 38 | 36 | 36 |
| | (ix) PTBP | g | 1.8 | 2.0 | 1.7 | 1.7 | 1.7 | 1.8 | 1.8 |
| | (x) Methylene chloride | mL | 12 | 14 | 12 | 12 | 12 | 12 | 12 |
| | (xi) NaOH | g | 10.3 | 9.1 | 9.9 | 9.9 | 9.9 | 9.3 | 9.3 |
| | (xii) Na₂S₂O₄ | mg | 39 | 38 | 38 | 38 | 38 | 33 | 32 |
| | (xiii) Pure water | mL | 151 | 133 | 145 | 145 | 145 | 135 | 135 |
| | (xiv) BPA | g | 19.6 | 18.9 | 18.9 | 18.9 | 18.9 | 16.7 | 15.8 |
| | (xv) MC | mL | 430 | 450 | 450 | 450 | 450 | 480 | 490 |

| | | | | | | | | Comparative | |
|---|---|---|---|---|---|---|---|---|---|
| | | | Production Example | | | | | Production Example | |
| | | | 8 | 9 | 10 | 11 | 12 | 3 | 4 |
| PC-POS copolymer | | | 8 | 9 | 10 | 11 | 12 | 23 | 24 |
| Production | (i) PCO | mL | 266 | 279 | 279 | 249 | 269 | 238 | 262 |
| condition | (ii) Methylene chloride | mL | 168 | 176 | 176 | 157 | 170 | 151 | 166 |
| | (iii) Cyclohexyl diphenolate | g | 12.6 | 10.6 | 8.2 | 16.5 | 10.7 | 16.6 | 10.8 |
| | (iv) Average chain length of | — | 90 | 37 | 37 | 37 | 37 | 37 | 37 |
| | POS | | | | | | | | |
| | (v) PDMS | g | 2.8 | 1.7 | 1.2 | 8.9 | 5.6 | 13.4 | 8.8 |
| | (vi) TEA | mL | 186 | 195 | 195 | 174 | 188 | 166 | 183 |
| | (vii) NaOH | g | 3.4 | 3.6 | 3.6 | 3.2 | 3.5 | 3.1 | 3.4 |
| | (viii) Pure water | mL | 40 | 42 | 42 | 37 | 40 | 36 | 39 |
| | (ix) PTBP | g | 1.8 | 1.9 | 1.9 | 1.7 | 1.8 | 1.7 | 1.8 |
| | (x) Methylene chloride | mL | 12 | 13 | 13 | 12 | 13 | 11 | 12 |
| | (xi) NaOH | g | 10.3 | 10.9 | 10.9 | 9.7 | 10.5 | 9.3 | 10.2 |
| | (xii) Na₂S₂O₄ | mg | 39 | 41 | 41 | 36 | 41 | 33 | 40 |
| | (xiii) Pure water | mL | 151 | 159 | 159 | 141 | 153 | 135 | 149 |
| | (xiv) BPA | g | 19.6 | 20.6 | 20.6 | 17.9 | 20.4 | 16.7 | 19.8 |
| | (xv) MC | mL | 430 | 400 | 390 | 450 | 420 | 470 | 430 |

TABLE 2

| | | | Production Example | | | | | | | |
|---|---|---|---|---|---|---|---|---|---|---|
| | | | 1 | 2 | 3 | 4 | 5 | 6 | 7 | 8 |
| PC-POS copolymer | | | 1 | 2 | 3 | 4 | 5 | 6 | 7 | 8 |
| Measurement | Content of repeating unit | mass | 84.9 | 84.1 | 81.6 | 80.3 | 77.8 | 73.4 | 68.3 | 85.0 |
| result | represented by formula | % | | | | | | | | |
| | (I)*¹ | | | | | | | | | |
| | Content of structural unit | mass | 12.7 | 13.5 | 15.8 | 15.8 | 16.1 | 20.2 | 23.7 | 12.5 |
| | represented by formula | % | | | | | | | | |
| | (II)*¹ | | | | | | | | | |
| | Content of repeating unit | mass | 2.4 | 2.4 | 2.5 | 3.9 | 6.1 | 6.3 | 8.0 | 2.5 |
| | represented by formula | % | | | | | | | | |
| | (III)*¹ | | | | | | | | | |
| | Content of structural unit | mass | 83.9 | 84.6 | 86.2 | 80.4 | 72.6 | 76.2 | 74.7 | 83.1 |
| | represented by formula | % | | | | | | | | |
| | (II)*² | | | | | | | | | |
| | Average number of | — | 36 | 38 | 40 | 40 | 38 | 38 | 38 | 95 |
| | repetitions of | | | | | | | | | |
| | polyorganosiloxane block | | | | | | | | | |
| | (A-2) | | | | | | | | | |
| | Viscosity-average | — | 23,400 | 19,500 | 23,600 | 24,100 | 23,600 | 22,500 | 22,200 | 23,000 |
| | molecular weight (Mv) | | | | | | | | | |
| | | | Production Example | | | | | | | |
| | | | 9 | 10 | 11 | 12 | 13 | 14 | 15 | 16 |
| PC-POS copolymer | | | 9 | 10 | 11 | 12 | 13 | 14 | 15 | 16 |
| Measurement | Content of repeating unit | mass | 88.4 | 90.6 | 75.6 | 85.2 | 84.3 | 83.8 | 85.3 | 83.9 |
| result | represented by formula | % | | | | | | | | |
| | (I)*¹ | | | | | | | | | |
| | Content of structural unit | mass | 10.1 | 8.2 | 16.3 | 10.2 | 13.2 | 13.6 | 12.2 | 13.5 |
| | represented by formula | % | | | | | | | | |
| | (II)*¹ | | | | | | | | | |
| | Content of repeating unit | mass | 1.4 | 1.1 | 8.0 | 4.7 | 2.4 | 2.7 | 2.4 | 2.5 |
| | represented by formula | % | | | | | | | | |
| | (III)*¹ | | | | | | | | | |
| | Content of structural unit | mass | 87.7 | 88.0 | 67.1 | 68.5 | 84.4 | 83.6 | 83.3 | 84.2 |
| | represented by formula | % | | | | | | | | |
| | (II)*² | | | | | | | | | |
| | Average number of | — | 35 | 41 | 36 | 38 | 38 | 36 | 38 | 37 |
| | repetitions of | | | | | | | | | |
| | polyorganosiloxane block | | | | | | | | | |
| | (A-2) | | | | | | | | | |
| | Viscosity-average | — | 22,300 | 21,900 | 22,900 | 22,700 | 22,300 | 25,800 | 21,200 | 22,800 |
| | molecular weight (Mv) | | | | | | | | | |

| | | | | | Comparative Production | | | |
|---|---|---|---|---|---|---|---|---|
| | | | Production Example | | Example | | | |
| | | | 17 | 18 | 1 | 2 | 3 | 4 |
| PC-POS copolymer | | | 17 | 18 | 21 | 22 | 23 | 24 |
| Measurement | Content of repeating unit | mass | 84.2 | 87.9 | 94.0 | 94.0 | 72.2 | 81.8 |
| result | represented by formula | % | | | | | | |
| | (I)*¹ | | | | | | | |
| | Content of structural unit | mass | 13.2 | 9.7 | 0 | 0 | 16.1 | 10.7 |
| | represented by formula | % | | | | | | |
| | (II)*¹ | | | | | | | |
| | Content of repeating unit | mass | 2.5 | 2.4 | 6.0 | 6.0 | 11.7 | 7.5 |
| | represented by formula | % | | | | | | |
| | (III)*¹ | | | | | | | |
| | Content of structural unit | mass | 83.9 | 80.1 | 0 | 0 | 58.0 | 58.7 |
| | represented by formula | % | | | | | | |
| | (II)*² | | | | | | | |
| | Average number of | — | 39 | 39 | 38 | 88 | 38 | 38 |
| | repetitions of | | | | | | | |
| | polyorganosiloxane block | | | | | | | |
| | (A-2) | | | | | | | |
| | Viscosity-average | — | 24,300 | 27,100 | 21,300 | 17,700 | 23,000 | 22,600 |
| | molecular weight (Mv) | | | | | | | |

*¹the content represents a ratio with respect to the total of the repeating unit represented by the formula (I), the structural unit represented by the formula (II), and the repeating unit represented by the formula (III).
*²the content represents a ratio with respect to the total of the structural unit represented by the formula (II) and the repeating unit represented by the formula (III).

### Examples 1 to 18 and Comparative Examples 1 to 5

### (Evaluation of Scratch Hardness (Pencil Method))

The PC-POS copolymers 1 to 18 and 21 to 24, and TARFLON FN2200 (product name, manufactured by Idemitsu Kosan Co., Ltd., aromatic polycarbonate-based resin formed of BPA, viscosity-average molecular weight Mv: 21,700) were each subjected to injection molding with an injection molding machine (“Mini Jet Pro” manufactured by Thermo Fisher Scientific, Inc.) under the conditions of a cylinder temperature of 290° C. and a mold temperature of 110° C. to produce a disc-shaped molded body (diameter: 30 mm, thickness: 1.5 mm).

A line was drawn on the basis of JIS K 5600 May 4:1999 with a pencil under a state in which a load of 750 g was applied to the pencil while an angle of 45° was kept. The presence or absence of a scratch on the surface was visually inspected, and the scratch hardness (pencil method) was evaluated. A pencil hardness determined by the scratch hardness (pencil method) is a pencil hardness on any one of the following 14 stages: 6B to B, HB, F, and H to 6H.

The results are shown in Table 3.

TABLE 3

| | | Example | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| PC-POS copolymer | | 1 | 2 | 3 | 4 | 5 | 6 | 7 | 8 | 9 | 10 | 11 | 12 |
| Evaluation | Scratch hardness | HB | HB | HB | HB | HB | HB | HB | HB | HB | HB | HB | HB |

| | | Example | | | | | | Comparative Example | | | | |
|---|---|---|---|---|---|---|---|---|---|---|---|---|
| | | 13 | 14 | 15 | 16 | 17 | 18 | 1 | 2 | 3 | 4 | 5 |
| PC-POS copolymer | | 13 | 14 | 15 | 16 | 17 | 18 | 21 | 22 | 23 | 24 | FN*¹ |
| Evaluation | Scratch hardness | HB | HB | HB | F | F | HB | B | B | B | B | B |

*¹the symbol “FN” means “TARFLON FN2200” manufactured by Idemitsu Kosan Co., Ltd.

As shown in Table 3, the molded bodies of the PC-POS copolymers 1 to 18 of the present invention were each excellent in scratch resistance.

Meanwhile, the molded bodies of the PC-POS copolymers 21 and 22, which were each free of the structural unit represented by the formula (II), the PC-POS copolymers 23 and 24, each of which included the structural unit represented by the formula (II), but did not sufficiently include the unit with respect to the total of the structural unit represented by the formula (II) and the repeating unit represented by the formula (III), and the TARFLON FN2200 were each poor in scratch resistance.

1. A polycarbonate-polyorganosiloxane copolymer, comprising:
a polycarbonate block (A-1) comprising a structural unit represented by the following formula (II); and
a polyorganosiloxane block (A-2) comprising a repeating unit represented by the following formula (III),
wherein a ratio of the structural unit represented by the formula (II) to a total of the structural unit represented by the formula (II) and the repeating unit represented by the formula (III) is 60 mass % or more: 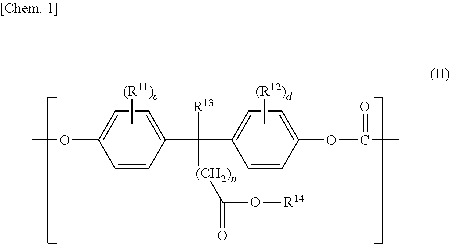
wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a group selected from the group consisting of: a saturated or unsaturated cyclic hydrocarbon group having 3 to 20 carbon atoms; a substituted or unsubstituted alkyl group; and a 3- to 20-membered saturated or unsaturated heterocyclic group,
“c” and “d” each independently represent an integer of from 0 to 4, and
“m” represents an integer of from 0 to 20; 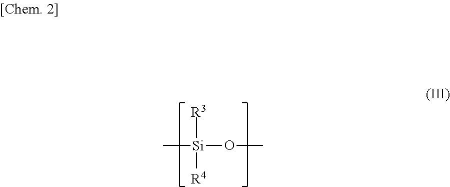
wherein in the formula (III), R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms.

2. The polycarbonate-polyorganosiloxane copolymer according to claim 1, wherein R¹⁴ represents an alkyl group having 1 to 18 carbon atoms, a saturated or unsaturated cyclic hydrocarbon group having 3 to 12 carbon atoms, or a 3- to 12-membered saturated or unsaturated heterocyclic group.

3. The polycarbonate-polyorganosiloxane copolymer according to claim 2, wherein R¹⁴ represents a methyl group, a cyclopentyl group, or a cyclohexyl group.

4. The polycarbonate-polyorganosiloxane copolymer according to claim 1, wherein “m” represents an integer of from 0 to 4.

5. The polycarbonate-polyorganosiloxane copolymer according to claim 1, wherein the repeating unit represented by the formula (III) is incorporated as a structural unit represented by any one of the following general formulae (III-I) to (III-III): 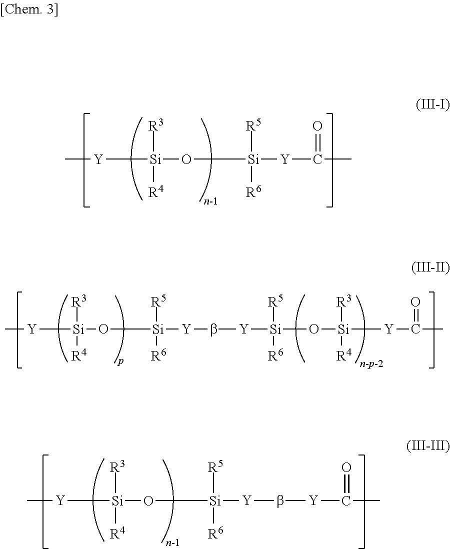
wherein in the formulae (III-I) to (III-III), R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s to R⁶s may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, —R⁷¹R⁷²—, a substituted or unsubstituted arylene group, or a diarylene group, R⁷¹ represents a linear, branched, or cyclic alkylene group, R⁷² represents a substituted or unsubstituted arylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, β represents a divalent group derived from a diisocyanate compound, or a divalent group derived from a dicarboxylic acid or a dicarboxylic acid halide, “n” represents an integer of 21 or more and less than 116, and “p” represents an integer of 1 or more and n−2 or less.

6. The polycarbonate-polyorganosiloxane copolymer according to claim 1, wherein the polycarbonate block (A-1) further comprises a repeating unit represented by the following formula (I): 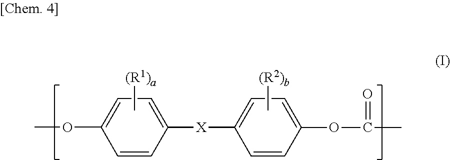
wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 6 to 20 carbon atoms; a cycloalkoxy group having 6 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and
“a” and “b” each independently represent an integer of from 0 to 4.

7. The polycarbonate-polyorganosiloxane copolymer according to claim 1, wherein a total content of the structural unit represented by the formula (II) and the repeating unit represented by the formula (III) is from 5 mass % to 35 mass %.

8. The polycarbonate-polyorganosiloxane copolymer according to claim 1, wherein the polycarbonate-polyorganosiloxane copolymer has a viscosity-average molecular weight (Mv) of from 10,000 to 40,000.

9. The polycarbonate-polyorganosiloxane copolymer according to claim 1, wherein “c” and “d” each independently represent an integer of from 1 to 4, and the polycarbonate-polyorganosiloxane copolymer has a viscosity-average molecular weight (Mv) of 22,000 or more.

10. The polycarbonate-polyorganosiloxane copolymer according to claim 1, wherein a molded article of the polycarbonate-polyorganosiloxane copolymer has a scratch hardness of HB or more, which is evaluated in conformity with JIS K5600 May 4.

11. A resin composition, comprising the polycarbonate-polyorganosiloxane copolymer of claim 1.

12. A molded article of the resin composition of claim 11.

13. The molded article according to claim 12, wherein the molded article is a resin window, a touch panel, an interior supply, an exterior supply, an interior part or an exterior part of a vehicle, a casing, an electric appliance part, a building material, or an OA equipment part.
